(19) United States
(12) Patent Application Publication
(10) Pub. No.: US 2024/0158646 A1
(43) Pub. Date: May 16, 2024

(54) METHOD FOR MANUFACTURING CONDUCTIVE PIGMENT PASTE

(71) Applicant: KANSAI PAINT CO., LTD., Hyogo (JP)

(72) Inventors: Koji ENDO, Kanagawa (JP); Masanao HASHIMURA, Kanagawa (JP); Takashi KITAMURA, Kanagawa (JP); Yoshiyuki YUKAWA, Aichi (JP)

(73) Assignee: KANSAI PAINT CO., LTD., Hyogo (JP)

(21) Appl. No.: 18/561,503

(22) PCT Filed: May 17, 2022
(86) PCT No.: PCT/JP2022/020559

§ 371 Date: Nov. 16, 2023

(30) Foreign Application Priority Data
May 17, 2021 (JP) 2021-082934
May 17, 2021 (JP) 2021-082935
Mar. 30, 2022 (JP) 2022-056117

(51) Int. Cl. C09D 5/24; C08K 3/04; C09D 7/40; C09D 7/45; C09D 7/61; C09D 7/65; C09D 7/80; C09D 129/04; H01M 4/04; H01M 4/62

(52) U.S. Cl. CPC C09D 5/24; C09D 7/45; C09D 7/61; C09D 7/65; C09D 7/67; C09D 7/80; C09D 129/04; H01M 4/0404; H01M 4/625; C08K 3/041; C08K 2201/001; C08K 2201/011

(57) ABSTRACT

The present invention relates to a solution to provide a conductive pigment paste that exhibits excellent pigment dispersibility and storage stability even as a paste with a high pigment concentration and/or high viscosity, and can be used to form a coating film excelling in conductivity and other properties. The present invention provides a method for manufacturing a conductive pigment paste. The method includes dispersing a paste containing a pigment dispersion resin (A), a conductive pigment (B), and a solvent (C) using at least one type of disperser selected from the group consisting of a bead mill, a homogenizer, an ultrasonic disperser, a kneader, an extruder, and a planetary mixer. The pigment dispersion resin (A) includes at least one polar functional group selected from the group consisting of an amide group, an imide group, an ether group, a hydroxyl group, a carboxyl group, a sulfonate group, a phosphate group, a silanol group, and an amino group, and the concentration of the polar functional group in the pigment dispersion resin (A) is from 9 to 23 mmol/g. The conductive pigment (B) contains carbon nanotubes (B-1) and/or a conductive carbon (B-2) having an average primary particle size from 10 to 80 nm. A solubility parameter δA of the pigment dispersion resin (A) and a solubility parameter δC of the solvent (C) satisfy a relationship of |δA−δC|<2.1.

### TECHNICAL FIELD

The present application claims the rights of priority based on JP 2021-082934 filed on May 17, 2021, JP 2021-082935 filed on May 17, 2021, and JP 2022-056117 filed on Mar. 30, 2022 (the entire disclosures of which are incorporated herein by reference). The present invention relates to a method for manufacturing a conductive pigment paste and a compounded paste, both excellent in pigment dispersibility and storage stability even at a high pigment concentration, and a method for manufacturing a battery electrode layer having excellent battery performance.

### BACKGROUND ART

Paste-like pigment dispersions in which a pigment is dispersed in a mixture of a pigment dispersion resin and a solvent have been widely used in fields such as paints, battery electrodes, application materials, coating materials, electromagnetic wave shields, display panels, touch screen panels, colored films, colored sheets, decorative materials, protective materials, magnet modifiers, printing inks, device members, electronic equipment members, printed wiring boards, solar cells, functional rubber members, and resin molded films. Further, these materials contain conductive pigments, conductive polymers and the like in order to impart functions such as an electrostatic coating property, conductivity, an electromagnetic wave shielding property, and an antistatic property.

In these fields, demands for improvements in performance aspects such as pigment dispersibility, storage stability, coatability, conductivity, and finish properties are increasing, and thus pigment dispersion resins and pigment pastes having excellent pigment dispersibility and excellent pigment dispersion stability sufficient for preventing re-aggregation of pigment particles in the formed pigment dispersion are being developed.

In designing a pigment paste, it is important to reduce the usage amounts of the solvent and pigment dispersion resin such that the pigment dispersion resin does not adversely affect the conductive performance or the like of the final product such as a coating film. Furthermore, from the viewpoint of reducing the energy that is used when drying, it is also important to create a highly concentrated and uniformly dispersed pigment paste with a small amount of a pigment dispersion resin.

For example, Patent Document 1 discloses a method for manufacturing an electrode slurry for a lithium secondary battery. The method is characterized in that a solvent containing fibrous carbon is dispersed by a media type disperser to produce a slurry, and the slurry is kneaded with an electrode active material to produce a slurry to be coated onto a current collector. However, in the case of a paste having a high pigment concentration and/or high viscosity, uniform dispersion cannot be achieved in some cases.

### CITATION LIST

### Patent Literature

Patent Document 1: JP 2014-182892 A

### SUMMARY OF INVENTION

### Technical Problem

Thus, an object of the present invention is to provide a conductive pigment paste that exhibits excellent pigment dispersibility and storage stability even as a paste with a high pigment concentration and/or high viscosity, and that can be used to form a coating film excelling in conductivity and other properties.

### Solution to Problem

The present inventors conducted diligent examinations to solve the above problem, and as a result, discovered that the problem can be solved by a method for manufacturing a conductive pigment paste by dispersing a paste containing a pigment dispersion resin (A), a conductive pigment (B), and a solvent (C) using at least one type of disperser selected from the group consisting of a bead mill, a homogenizer, an ultrasonic disperser, a kneader, an extruder, and a planetary mixer. The pigment dispersion resin (A) includes at least one polar functional group selected from the group consisting of an amide group, an imide group, an ether group, a hydroxyl group, a carboxyl group, a sulfonate group, a phosphate group, a silanol group, and an amino group, and the concentration of the polar functional group in the pigment dispersion resin (A) is from 9 to 23 mmol/g. The conductive pigment (B) contains carbon nanotubes (B-1) and/or a conductive carbon (B-2) having an average primary particle size from 10 to 80 nm. A solubility parameter δA of the pigment dispersion resin (A) and a solubility parameter δC of the solvent (C) satisfy a relationship of |δA−δC|<2.1. The present inventors also discovered a method that is effective for improving the dispersibility and storage stability of the pigment conductive pigment paste and for improving the conductivity and other properties of a coating film produced using the conductive pigment paste, namely a method of charging a powder raw material (P) containing a predetermined conductive pigment (B) into a predetermined liquid raw material and pre-mixing and dispersing using a media-less disperser, and more specifically, a method for manufacturing a conductive pigment paste containing a pigment dispersion resin (A), a conductive pigment (B), and a solvent (C). The pigment dispersion resin (A) has at least one polar functional group selected from the group consisting of an amide group, an imide group, an ether group, a hydroxyl group, a carboxyl group, a sulfonate group, a phosphate group, a silanol group, and an amino group, and the concentration of the polar functional group in the pigment dispersion resin (A) is from 9 to 23 mmol/g. The conductive pigment (B) contains carbon nanotubes (B-1) and/or a conductive carbon (B-2) having an average primary particle size from 10 to 80 nm. A powder raw material (P) containing the conductive pigment (B) is inserted into a liquid raw material (L) produced by mixing the pigment dispersion resin (A), the solvent (C), and any other optionally selected component, and the mixture is mixed and dispersed using a media-less disperser. As a result of repeated trials based on these novel findings, the present inventors arrived at the present invention.

That is, the present invention provides the following methods for manufacturing a conductive pigment paste, a compounded paste, and a battery electrode layer.

Aspect 1. A method for manufacturing a conductive pigment paste, the method including dispersing a paste containing a pigment dispersion resin (A), a conductive pigment (B), and a solvent (C) using at least one type of disperser selected from the group consisting of a bead mill, a homogenizer, an ultrasonic disperser, a kneader, an extruder, and a planetary mixer, wherein
the pigment dispersion resin (A) has at least one polar functional group selected from the group consisting of an amide group, an imide group, an ether group, a hydroxyl group, a carboxyl group, a sulfonate group, a phosphate group, a silanol group, and an amino group, and a polar functional group concentration in the pigment dispersion resin (A) is from 9 to 23 mmol/g,
the conductive pigment (B) contains carbon nanotubes (B-1) and/or a conductive carbon (B-2) having an average primary particle size from 10 to 80 nm, and
a solubility parameter δA of the pigment dispersion resin (A) and a solubility parameter δC of the solvent (C) satisfy a relationship of |δA−δC|<2.1.

Aspect 2. The method according to aspect 1, wherein the conductive pigment paste further includes, prior to the dispersing using at least one type of disperser, a step of charging a powder raw material (P) containing the conductive pigment (B) into a liquid raw material (L) containing the pigment dispersion resin (A) and the solvent (C), and mixing and dispersing using a media-less disperser.

Aspect 3. The method according to aspect 1 or 2, wherein the bead mill is an annular bead mill.

Aspect 4. The method according to aspect 3, wherein the annular bead mill is a biaxial driving-type annular bead mill.

Aspect 5. The method according to aspect 1 or 2, wherein the homogenizer is an ultra-high speed homogenizer or a high pressure homogenizer.

Aspect 6. The method for manufacturing a conductive pigment paste according to any one of aspects 1 to 5, wherein the pigment dispersion resin (A) contains an ionic polyvinyl alcohol.

Aspect 7. The method for manufacturing a conductive pigment paste according to aspect 6, wherein a degree of saponification of the ionic polyvinyl alcohol is greater than or equal to 85 mol % and less than 100 mol %.

Aspect 8. The method for manufacturing a conductive pigment paste according to any one of aspects 1 to 7, wherein a solid content of the pigment dispersion resin (A) is from 0.1 to 50 mass % based on a total solid content of the conductive pigment paste.

Aspect 9. The method for manufacturing a conductive pigment paste according to any one of aspects 1 to 8, wherein a content of the conductive pigment (B) is from 1 to 90 mass % based on a total amount of the conductive pigment paste, and is from 10 to 99.9 mass % based on the total solid content of the conductive pigment paste.

Aspect 10. The method for manufacturing a conductive pigment paste according to any one of aspects 1 to 9, wherein the carbon nanotubes (B-1) contain multi-walled carbon nanotubes.

Aspect 11. The method for manufacturing a conductive pigment paste according to any one of aspects 1 to 10, wherein the conductive pigment (B) is the carbon nanotubes (B-1).

Aspect 12. The method for manufacturing a conductive pigment paste according to aspect 10 or 11, wherein the solid content of the pigment dispersion resin (A) is from 5 to 50 mass % based on the total solid content of the conductive pigment paste.

Aspect 13. The method for manufacturing a conductive pigment paste according to any one of aspects 10 to 12, wherein the content of the carbon nanotubes (B-1) is from 1 to 20 mass % based on the total amount of the conductive pigment paste, and is from 10 to 99 mass % based on the total solid content of the conductive pigment paste.

Aspect 14. A method for manufacturing a conductive pigment paste, wherein the conductive pigment paste produced by the method described in any one of aspects 11 to 13 is diluted with a solvent, and an average particle size D50 determined by volume-based particle size distribution measurements according to a laser diffraction-scattering method is from 0.8 to 4 μm.

Aspect 15. A method for manufacturing a conductive pigment paste, wherein the conductive pigment paste produced by the method described in any one of aspects 11 to 13 is diluted with a solvent, and a standard deviation of a particle size distribution determined by volume-based particle size distribution measurements according to a laser diffraction-scattering method is 3 μm or less.

Aspect 16. The method for manufacturing a conductive pigment paste according to any one of aspects 1 to 10, wherein the conductive pigment (B) is the conductive carbon (B-2) having an average primary particle size from 10 to 80 nm.

Aspect 17. The method for manufacturing a conductive pigment paste according to aspect 16, wherein the solid content of the pigment dispersion resin (A) is from 0.1 to 20 mass % based on the total solid content of the conductive pigment paste.

Aspect 18. The method for manufacturing a conductive pigment paste according to aspect 16 or 17, wherein a content of the conductive carbon (B-2) having an average primary particle size from 10 to 80 nm is from 5 to 90 mass % based on the total amount of the conductive pigment paste, and is from 40 to 99.9 mass % based on the total solid content of the conductive pigment paste.

Aspect 19. The method for manufacturing a conductive pigment paste according to any one of aspects 1 to 18, wherein the conductive carbon (B-2) having an average primary particle size from 10 to 80 nm is at least one selected from the group consisting of acetylene black. Ketjen black, furnace black, thermal black, graphene, and graphite.

Aspect 20. The method for manufacturing a conductive pigment paste according to any one of aspects 1 to 19, wherein the solubility parameter δA of the pigment dispersion resin (A) is 9.3 or greater, and the solubility parameter δC of the solvent (C) is from 10.4 to 15.0.

Aspect 21. The method for manufacturing a conductive pigment paste according to any one of aspects 1 to 20, wherein the conductive pigment paste further contains from 0.01 to 500 mass % of a highly-polar low-molecular weight component based on the conductive pigment (B).

Aspect 22. The method for manufacturing a conductive pigment paste according to any one of aspects 1 to 21, wherein the conductive pigment paste further contains a film-forming resin (D) having a weight average molecular weight of 100000 or greater and a solubility parameter δD of less than 9.3.

Aspect 23. A method for manufacturing a conductive pigment paste, wherein the conductive pigment paste produced by the method described in any one of aspects 1 to 22 is substantially free of water.

Aspect 24. A method for manufacturing a conductive pigment paste, wherein the conductive pigment paste produced by the method described in any one of aspects 1 to 23 is substantially free of metal.

Aspect 25. The method for manufacturing a conductive pigment paste according to any one of aspects 1 to 4 and 6 to 24, wherein the bead mill is a bead mill having an inner surface coated with a material other than a metal.

Aspect 26. A method for manufacturing an electrode compounded paste, the method including adding at least one electrode active material to the conductive pigment paste manufactured by the method described in any one of aspects 1 to 25.

Aspect 27. A method for manufacturing a battery electrode layer produced by coating a current collector with the electrode compounded paste produced by the method described in aspect 26.

### Advantageous Effects of Invention

The method for manufacturing a conductive pigment paste of the present invention excels in pigment dispersibility and storage stability even at a high pigment concentration and/or high viscosity, and can sufficiently reduce the viscosity of the paste with a relatively small blending amount of a dispersion resin. In addition, the coating film formed thereby exhibits excellent conductivity, battery performance, and the like.

### DESCRIPTION OF EMBODIMENTS

Hereinafter, embodiments for carrying out the present invention will be described in detail.

Note that it should be understood that the present invention is not limited to the following embodiments and includes various modified examples carried out without departing from the gist of the present invention.

In the present invention, first, a conductive pigment paste containing the conductive pigment (B) in an appropriately dispersed state is prepared, and then various components are added to the conductive pigment paste in order to form a coating film satisfying various performance requirements, and thereby a compounded paste is manufactured.

In the present invention, a paste prepared by further blending at least one kind of electrode active material and any other optionally selected components for applying the conductive pigment paste is referred to as a “compounded paste”. A product produced by applying the compounded paste onto an object to be coated and drying is referred to as a “coating film”. When the coating film is used for a battery electrode, it can also be referred to as an “electrode layer”.

In one embodiment, the present invention provides a method for manufacturing a conductive pigment paste. The method includes dispersing a paste containing a pigment dispersion resin (A), a conductive pigment (B), and a solvent (C) using at least one type of disperser selected from the group consisting of a bead mill, a homogenizer, an ultrasonic disperser, a kneader, an extruder, and a planetary mixer. The pigment dispersion resin (A) includes at least one polar functional group selected from the group consisting of an amide group, an imide group, an ether group, a hydroxyl group, a carboxyl group, a sulfonate group, a phosphate group, a silanol group, and an amino group, and the concentration of the polar functional group in the pigment dispersion resin (A) is from 9 to 23 mmol/g. The conductive pigment (B) contains carbon nanotubes (B-1) and/or a conductive carbon (B-2) having an average primary particle size from 10 to 80 nm. A solubility parameter δA of the pigment dispersion resin (A) and a solubility parameter δC of the solvent (C) satisfy a relationship of |A−δC|<2.1.

Here, the solubility parameter is generally called an SP value (solubility parameter), and is a measure indicating the degree of hydrophilicity or hydrophobicity (polarity) of a solvent or a resin. In addition, the solubility parameter is an important measure for determining the solubility or miscibility between a solvent and a resin or between resins. When the values of the solubility parameters are close to each other (that is, when the absolute value of the difference between the solubility parameters is small), the solubility or miscibility is generally good. In the present invention, “dispersing a paste containing a pigment dispersion resin (A), a conductive pigment (B), and a solvent (C)” means that in a mixture containing the pigment dispersion resin (A), the conductive pigment (B), and the solvent (C), the conductive pigment (B) is dispersed in the pigment dispersion resin (A) and the solvent (C). The phrase “dispersing a paste” also includes breaking up clumps of the conductive pigment (B) in the paste containing the pigment dispersion resin (A), the conductive pigment (B), and the solvent (C) to disperse smaller clumps of the conductive pigment (B) in the paste.

### Pigment Dispersion Resin (A)

The pigment dispersion resin (A), which can be used as a component of the conductive pigment paste, contains at least one polar functional group selected from the group consisting of an amide group, an imide group, an ether group, a hydroxyl group, a carboxyl group, a sulfonate group, a phosphate group, a silanol group, and an amino group. Moreover, from the viewpoints of dispersibility, storage stability, and miscibility with the solvent, the concentration of the polar functional group in the resin (A) is usually from 9 to 23 mmol/g, preferably from 10 to 22.5 mmol/g, more preferably from 11 to 22 mmol/g, and even more preferably from 12 to 22 mmol/g.

In addition, from the viewpoints of dispersibility, storage stability, and miscibility with the solvent, the solubility parameter δA of the pigment dispersion resin (A) is preferably 9.3 or greater, more preferably from 10.0 to 13.0, and still more preferably from 11.0 to 12.5.

The solubility parameter of the resin is numerically quantified on the basis of a turbidity measurement method known to a person skilled in the art, and specifically, can be determined according to an equation stipulated by K. W. SUH and J. M. CORBETT (Journal of Applied Polymer Science, 12, 2359, 1%8).

Note that in the present invention, the unit of the solubility parameter (of the resin and solvent) is “(cal/cm³)^{1/2}”.

In a case in which two or more types of pigment dispersion resins (A) are used, the “solubility parameter δA of the pigment dispersion resin (A)” is a value calculated by multiplying the solubility parameter value of each resin by the mass fraction of the resin and then totaling the products thereof.

Specific examples of the types of resins include acrylic resins, polyester resins, epoxy resins, polyether resins, alkyd resins, urethane resins, polyvinyl alcohol, polyvinyl acetal, polyvinyl pyrrolidone, polyvinyl acetate, silicone resins, polycarbonate resins, silicate resins, chlorine-based resins, fluorine-based resins, and composite resins thereof. A single type of these resins can be used alone, or two or more types thereof can be used in combination.

From the viewpoint of imparting sufficient film-forming properties to the conductive coating film without reducing the excellent conductivity of the conductive coating film formed from the paste, among these resins, the pigment dispersion resin (A) preferably contains a vinyl (co)polymer (A-1) produced by polymerizing or copolymerizing a monomer including a polymerizable unsaturated group-containing monomer represented by the following Formula (1). Note that the term “(co)polymer” in the present invention includes both a polymer produced by polymerizing one type of monomer and a copolymer produced by copolymerizing two or more types of monomers.

C(—R)₂═C(—R)₂ Formula (1)

(In the above Formula (1), each R may be the same or different and represents a hydrogen atom or an organic group.)

The vinyl (co)polymer (A-1) preferably contains, in the structure thereof, a structural unit represented by “—CH₂—CH(—X)—” (where X is an organic group having a polar functional group), and the polar functional group X in the structural unit is at least one polar functional group selected from the group consisting of an amide group, an imide group, an ether group, a hydroxyl group, a carboxyl group, a pyrrolidone group (2-oxopyrrolidin-1-yl group), a sulfonate group, a phosphate group, a silanol groups, and an amino group.

Examples of the vinyl (co)polymer (A-1) include an amide group-containing vinyl (co)polymer, an imide group-containing vinyl (co)polymer, an ether group-containing vinyl (co)polymer, a hydroxyl group-containing vinyl (co)polymer, a carboxyl group-containing vinyl (co)polymer, a pyrrolidone group-containing vinyl (co)polymer, a sulfonate group-containing vinyl (co)polymer, a phosphate group-containing vinyl (co)polymer, and an amino group-containing vinyl (co)polymer. A single type of these (co)polymers can be used alone or two or more types thereof can be used in a combination.

Examples of the amide group-containing vinyl (co)polymer include a polymer of (meth)acrylamide, or a copolymer of (meth)acrylamide and another polymerizable unsaturated monomer.

Examples of the imide group-containing vinyl (co)polymer include a polymer of (meth)acrylimide, or a copolymer of (meth)acrylimide and another polymerizable unsaturated monomer.

Examples of the ether group-containing vinyl (co)polymer include a polymer of polyethylene glycol monomethyl ether (meth)acrylate, or a copolymer of polyethylene glycol monomethyl ether (meth)acrylate and another polymerizable unsaturated monomer.

Examples of the hydroxyl group-containing vinyl (co)polymer include polyhydroxyethyl (meth)acrylate, polyvinyl alcohol, a vinyl alcohol-fatty acid vinyl copolymer, a vinyl alcohol-ethylene copolymer, a vinyl alcohol-(N-vinylformamide) copolymer, and a copolymer of hydroxyethyl (meth)acrylate and another polymerizable unsaturated monomer. The vinyl alcohol unit in the (co)polymer may be one produced by (co)polymerizing a fatty acid vinyl unit and then subjecting to hydrolysis.

Examples of the carboxyl group-containing vinyl (co)polymer include a polymer of (meth)acrylic acid, or a copolymer of poly (meth)acrylic acid and another polymerizable unsaturated monomer.

Examples of the pyrrolidone group-containing vinyl (co)polymer include polyvinylpyrrolidone, an N-vinyl-2-pyrrolidone-ethylene copolymer, and an N-vinyl-2-pyrrolidone-vinyl acetate copolymer.

Examples of the sulfonate group-containing vinyl (co)polymer include a polymer of allyl sulfonic acid or styrene sulfonic acid, and a copolymer of allyl sulfonic acid and/or styrene sulfonic acid and another polymerizable unsaturated monomer.

Examples of the phosphate group-containing vinyl (co)polymer include a polymer of a (meth)acryloyloxyalkyl acid phosphate, or a copolymer of (meth)acryloyloxyalkyl acid phosphate and another polymerizable unsaturated monomer.

Examples of the amino group-containing vinyl (co)polymer include a polymer of polyvinylamine, polyallylamine, or dimethylaminoethyl (meth)acrylate, and a copolymer of dimethylaminoethyl (meth)acrylate and another polymerizable unsaturated monomer.

In these embodiments, the “other polymerizable unsaturated monomer” is not particularly limited, and examples thereof include those listed as the below-described “polymerizable unsaturated group-containing monomer that can be copolymerized”, and vinyl acetate and the like are preferable.

Among these vinyl (co)polymers (A-1), from the viewpoint of improving the dispersibility and reducing the surface resistivity of the conductive coating film, a hydroxyl group-containing polyvinyl (co)polymer, a carboxyl group-containing polyvinyl (co)polymer, and a pyrrolidone group-containing polyvinyl (co)polymer are preferable, and a hydroxyl group-containing polyvinyl (co)polymer is more preferable. Among the hydroxyl group-containing polyvinyl (co)polymers, polyvinyl alcohol (co)polymers are particularly preferable.

From the viewpoint of dispersibility, the degree of saponification of the polyvinyl alcohol (co)polymer is preferably greater than or equal to 55 mol % and less than 100 mol %, more preferably greater than or equal to 85 mol % and less than 100 mol %, even more preferably greater than or equal to 90 mol % and less than 100 mol %, and particularly preferably greater than or equal to 95 mol % and less than 100 mol %.

Among the polyvinyl alcohol (co)polymers, an ionic polyvinyl alcohol having an ionic functional group is particularly preferable from the viewpoint of dispersibility. Examples of the ionic functional group include a carboxyl group, a sulfonate group, a phosphate group, and an amino group. The ionic polyvinyl alcohol can be produced by the following methods.

(1) A method in which a compound containing an ionic functional group and a polymerizable unsaturated group is copolymerized with a fatty acid vinyl ester such as vinyl acetate, and the resulting polymer is further saponified.

(2) A method in which a compound containing an ionic functional group and a polymerizable unsaturated group is added to polyvinyl alcohol by Michael addition.

(3) A method in which polyvinyl alcohol is heated with an aqueous solution (such as an aqueous acetic acid solution, an aqueous sulfuric acid solution, an aqueous phosphoric acid solution, or an aqueous ammonia solution) corresponding to a functional group to be modified.

(4) A method in which polyvinyl alcohol is acetalized with an aldehyde compound containing an ionic functional group.

(5) A method in which polyvinyl alcohol is polymerized in the presence of, as chain transfer agents, an alcohol having an ionic functional group, an aldehyde, and a compound having a functional group such as thiol.

Any manufacturing method can be suitably used, but the method (1) is particularly preferable.

In these embodiments, examples of the compound containing an ionic functional group and a polymerizable unsaturated group include compounds containing a carboxyl group and a polymerizable unsaturated group (e.g., acrylic acid, methacrylic acid, etc.), compounds containing a sulfonate group and a polymerizable unsaturated group (e.g., allyl sulfonic acid, styrene sulfonic acid, etc.), compounds containing a phosphate group and a polymerizable unsaturated group (e.g., (meth)acryloyloxyalkyl acid phosphate, etc.), and compounds containing an amino group and a polymerizable unsaturated group (e.g., vinylamine, allylamine, dimethylaminoethyl (meth)acrylate, etc.).

Note that in addition to the above-described structural unit represented by “—CH₂—CH(—X)—”, the vinyl (co)polymer (A-1) may optionally contain a structural unit derived from a polymerizable unsaturated group-containing monomer that can be copolymerized. Examples of the polymerizable unsaturated group-containing monomer that can be copolymerized include vinyl carboxylate monomers, such as vinyl formate, vinyl acetate, vinyl propionate, isopropenyl acetate, vinyl valerate, vinyl caprylate, vinyl caprate, vinyl laurate, vinyl stearate, vinyl benzoate, vinyl versatate, and vinyl pivalate; olefins such as ethylene, propylene, and butylene; aromatic vinyls such as styrene and α-methylstyrene; ethylenically unsaturated carboxylic acid monomers such as methacrylic acid, fumaric acid, maleic acid, itaconic acid, monoethyl fumarate, maleic anhydride and itaconic anhydride; ethylenically unsaturated alkyl carboxylate monomers such as methyl (meth)acrylate, ethyl (meth)acrylate, n-butyl (meth)acrylate, 2-ethylhexyl (meth)acrylate, dimethyl fumarate, dimethyl maleate, diethyl maleate, and diisopropyl itaconate; vinyl ether monomers such as methyl vinyl ether, n-propyl vinyl ether, isobutyl vinyl ether and dodecyl vinyl ether; ethylenically unsaturated nitrile monomers such as (meth)acrylonitrile; halogenated vinyl monomers or vinylidene monomers, such as vinyl chloride, vinylidene chloride, vinyl fluoride and vinylidene fluoride; allyl compounds such as allyl acetate and allyl chloride; sulfonate group-containing monomers such as ethylene sulfonate, (meth)allyl sulfonate, and 2-acrylamido-2-methylpropanesulfonic acid; quaternary ammonium group-containing monomers such as 3-(meth)acrylamidopropyl trimethylammonium chloride; and vinyltnmethoxysilane, N-vinylformamide, and methacrylamide. A single type of these monomers can be used alone or two or more types thereof can be used in a combination.

The vinyl (co)polymer (A-1) can be produced by a known polymerization method, and for example, solution polymerization is preferably used. However, the polymerization method is not limited thereto, and bulk polymerization, emulsion polymerization, suspension polymerization, or the like may be used. When solution polymerization is used, continuous polymerization or batch polymerization may be carried out, and the monomers may be charged all at once or in portions, or may be added continuously or intermittently.

The polymerization initiator used in solution polymerization is not particularly limited, and specific examples of polymerization initiators that can be used include known radical polymerization initiators, including azo compounds such as azobisisobutyronitrile, azobis-2,4-dimethylvaleronitrile and azobis (4-methoxy-2,4-dimethylvaleronitrile); peroxides such as acetyl peroxide, benzoyl peroxide, lauroyl peroxide, acetylcyclohexylsulfonyl peroxide and 2,4,4-trimethylpentyl-2-peroxyphenoxyacetate; percarbonate compounds such as diisopropyl peroxydicarbonate, di-2-ethylhexyl peroxydicarbonate and diethoxyethyl peroxydicarbonate; perester compounds such as t-butyl peroxyneodecanoate, α-cumyl peroxyneodecanoate, and t-butyl peroxyneodecanoate; and azobis-dimethylvaleronitrile and azobis-methoxyvaleronitrile.

The polymerization reaction temperature is not particularly limited, but can usually be set in an approximate range from 30 to 200° C.

The vinyl (co)polymer (A-1) that can be produced in this manner preferably has a degree of polymerization from 100 to 4000, and more preferably from 100 to 3000, or from 150 to 700.

Moreover, the weight average molecular weight of the vinyl (co)polymer (A-1) is preferably from 1000 to 200000, more preferably from 2000 to 100000, and even more preferably from 7000 to 30000.

By performing desolvation and/or solvent displacement after completion of synthesis, the vinyl (co)polymer (A-1) can be made into a solid or a resin solution in which the original solvent has been replaced with an optionally selected solvent.

The desolvation may be performed by heating at normal pressure or may be performed under reduced pressure. The solvent displacement may be performed by charging a displacement solvent at any stage before, during or after desolvation.

From the viewpoints of dispersibility, storage stability, and conductivity, the solid content of the pigment dispersion resin (A) is preferably 0.1 mass % or greater, more preferably 0.3 mass % or greater, even more preferably 0.5 mass % or greater, yet even more preferably 1 mass % or greater, still more preferably 5 mass % or greater, and particularly preferably 10 mass % or greater, based on the total solid content of the conductive pigment paste. The upper limit of the solid content of the pigment dispersion resin (A) is preferably 50 mass % or less, more preferably 40 mass % or less, still more preferably 35 mass % or less, and particularly preferably 30 mass % or less, based on the total solid content of the conductive pigment paste. The range of the solid content of the pigment dispersion resin (A) is preferably from 1 to 50 mass %, more preferably from 5 to 40 mass %, and particularly preferably from 10 to 30 mass %, based on the total solid content of the conductive pigment paste.

Particularly in an embodiment in which the conductive pigment paste manufactured by the method of the present invention contains the carbon nanotubes (B-1) as the conductive pigment (B), from the viewpoints of dispersibility and storage stability, the solid content of the pigment dispersion resin (A) is preferably from 5 to 50 mass %, more preferably from 8 to 40 mass %, and even more preferably from 10 to 30 mass % based on the total solid content of the conductive pigment paste.

Furthermore, in particularly an embodiment in which the conductive pigment paste manufactured by the method of the present invention does not contain the carbon nanotubes (B-1) as the conductive pigment (B), from the viewpoints of dispersibility and storage stability, the solid content of the pigment dispersion resin (A) is preferably from 0.1 to 20 mass %, more preferably from 0.5 to 15 mass %, and even more preferably from 1 to 10 mass % based on the total solid content of the conductive pigment paste.

### Conductive Pigment (B)

The conductive pigment (B) used in the present invention contains carbon nanotubes (B-1) and/or a conductive carbon (B-2) having an average primary particle size from 10 to 80 nm.

As the carbon nanotubes (B-1), either of single-walled carbon nanotubes or multi-walled carbon nanotubes can be used alone or both of them can be used in combination. In particular, from a relationship between viscosity, conductivity, and cost, multi-walled carbon nanotubes are preferably used.

The outer diameter of the carbon nanotubes (B-1) is preferably from 1 to 25 nm, more preferably from 3 to 20 nm, and particularly preferably from 5 to 15 nm.

The length of the carbon nanotubes (B-1) is preferably from 1 to 100 μm, more preferably from 5 to 80 μm, and particularly preferably from 10 to 60 μm.

In view of the relationship between viscosity and conductivity, the specific surface area of the carbon nanotubes (B-1) is preferably in a range from 1 to 1000 m²/g, and more preferably in a range from 10 to 500 m²% g.

Examples of the conductive carbon (B-2) having an average primary particle size from 10 to 80 nm include spherical, ellipsoidal, plate-shaped, scale-shaped, or irregular-shaped conductive carbon other than the carbon nanotubes (B-1). From the viewpoints of the finish property, conductivity, and the like of the formed coating film, the average primary particle size of the conductive carbon (B-2) is usually from 10 to 80 nm, preferably from 15 to 60 nm, and more preferably from 20 to 50 nm.

Here, the average primary particle size in the present invention refers to an average size of primary particles determined by observing the pigment with an electron microscope, measuring a projected surface area of each of 100 particles, deriving a diameter based on the assumption of a circle equal to the projected surface area, and simply averaging the diameters of the 100 particles. Note that when the pigment is in an aggregated state, the average primary particle size is calculated using the primary particles constituting the aggregated particles.

Specific examples of the types of conductive carbons (B-2) include acetylene black, Ketjen black, furnace black, thermal black, graphene, and graphite, and acetylene black is preferable. A single type of these conductive carbons can be used alone or two or more types thereof can be used in a combination.

In view of the relationship between the viscosity and conductivity, the specific surface area of the conductive carbon (B-2) is preferably in a range from 1 to 500 m²/g, and more preferably in a range from 30 to 150 m²/g.

From the relationship of pigment dispersibility, the conductive carbon (B-2) is preferably basic, and specifically, the pH of the conductive carbon (B-2) is preferably 7.5 or greater, more preferably from 8.0 to 12.0, and even more preferably from 8.5 to 11.0.

In addition, from the viewpoint of conductivity, the conductive carbon (B-2) is preferably in a state in which the primary particles form a chain structure, and the structure index is more preferably in a range from 1.5 to 4.0, and particularly preferably in a range from 1.7 to 3.2.

Although the structure itself can be relatively easily observed even in an image captured by an electron microscope, the structure index is a numerical value by which the degree of the structure is quantified. The structure index can be generally defined as a value calculated by dividing the DBP oil absorption amount (mL/100 g) by the specific surface area (m²/g). When the structure index is less than 1.5, sufficient conductivity cannot be achieved because the structure is not developed. When the structure index exceeds 4.0, the particle size is large in relation to the DBP oil absorption amount, and thus the conductive paths are reduced, and sufficient conductivity may not be exhibited or the viscosity of the compounded paste may increase.

The conductive pigment (B) may contain a conductive pigment other than the carbon nanotubes (B-1) and/or the conductive carbon (B-2) having an average primary particle size from 10 to 80 nm. The conductive pigment is not particularly limited as long as the conductive pigment can impart electrical conductivity to the coating film to be formed, and examples include pigments in the shape of particles, flakes, and fibers (including whiskers). Specific examples include metal powders, such as those of silver, nickel, copper, graphite, and aluminum; and furthermore, an antimony-doped tin oxide, a phosphorus-doped tin oxide, an acicular titanium oxide surface-coated with a tin oxide/antimony, an antimony oxide, a zinc antimonate, an indium tin oxide, pigments produced by coating a whisker surface of carbon or graphite with a tin oxide or the like; pigments produced by coating a surface of flaky mica with at least one type of conductive metal oxide selected from the group consisting of tin oxide, antimony-doped tin oxide, tin-doped indium oxide (ITO), fluorine-doped tin oxide (FTO), phosphorus-doped tin oxide, and nickel oxide; and conductive pigments containing tin oxide and phosphorus on a surface of a titanium dioxide particle. Furthermore, two or more of the above-described conductive pigments can be combined and used.

From the viewpoints of conductivity and pigment dispersibility, the content of the conductive pigment (B) is preferably from 1 to 90 mass %, more preferably from 3 to 70 mass %, and particularly preferably from 5 to 50 mass %, based on the total amount of the conductive pigment paste. The content of the conductive pigment (B) is preferably from 10 to 99.9 mass %, more preferably from 30 to 99 mass %, and particularly preferably from 50 to 98 mass % based on the total solid content of the conductive pigment paste.

Particularly in an embodiment in which the conductive pigment (B) contains the carbon nanotubes (B-1), from the viewpoints of conductivity and pigment dispersibility, the content of the carbon nanotubes (B-1) is preferably from 1 to 20 mass %, more preferably from 2 to 18 mass %, even more preferably from 2 to 15 mass %, and yet even more preferably from 3 to 15 mass %, based on the total amount of the conductive pigment paste. In such an embodiment, the content of the conductive pigment (B) is preferably from 10 to 99 mass %, more preferably from 30 to 95 mass %, and particularly preferably from 50 to 90 mass % based on the total solid content of the conductive pigment paste.

Particularly in an embodiment in which the conductive pigment (B) contains the conductive carbon (B-2) having an average primary particle size from 10 to 80 nm, from the viewpoints of conductivity and pigment dispersibility, the content of the conductive carbon (B-2) is preferably from 5 to 90 mass %, more preferably from 10 to 80 mass %, and even more preferably from 20 to 70 mass %, based on the total amount of the conductive pigment paste.

In such an embodiment, the content of the conductive pigment (B) is preferably from 40 to 99.9 mass %, more preferably from 50 to 99 mass %, and particularly preferably from 60 to 98 mass %, based on the total solid content of the conductive pigment paste.

In a case in which the conductive pigment (B) contains both the carbon nanotubes (B-1) and the conductive carbon (B-2) having an average primary particle size from 10 to 80 nm, a weight ratio (B-1)/(B-2) is preferably in a range from 0.1/99.9 to 99.9/0.1, and more preferably in a range from 1/99 to 90/10.

### Solvent (C)

As the solvent (C) that can be used in the conductive pigment paste, a known solvent can be used without particular limitation. Specific examples of the solvent (C) include hydrocarbon solvents such as n-butane, n-hexane, n-heptane, n-octane, cyclopentane, cyclohexane, and cyclobutane; aromatic solvents such as toluene, and xylene; ketone-based solvents such as methylisobutylketone; ether-based solvents such as n-butylether, dioxane, ethyleneglycol monomethylether, ethyleneglycol monoethylether, ethyleneglycol monoethylether, ethyleneglycol monobutylether, and diethyleneglycol; ester-based solvents such as ethyl acetate, n-butyl acetate, isobutyl acetate, ethyleneglycol monomethylether acetate, and butylcarbitol acetate; ketone-based solvents such as methylethylketone, methylisobutylketone, and diisobutylketone; alcohol-based solvents such as ethanol, isopropanol, n-butanol, sec-butanol, and isobutanol; and amide-based solvents such as EQUAMIDE (trade name, available from Idemitsu Kosan Co., Ltd., amide-based solvent), N,N-dimethylformamide, N,N-dimethylacetamide, N-methylformamide, N-methylacetamide, N-methylpropionamide, and N-methyl-2-pyrrolidone. A single type of these solvents can be used alone or two or more types thereof can be used in combination.

From the viewpoints of solubility of the pigment dispersion resin (A) and dispersion stability of the conductive pigment paste, among these solvents, the solvent (C) that can be used in the conductive pigment paste preferably contains a solvent having a polar functional group such as a hydroxyl group, a carboxyl group, an amide group, an amino group, or an ether group.

In addition, from the viewpoints of dispersibility of the conductive pigment paste and prevention of deterioration or hydrolysis of the resin, the solvent (C) is preferably substantially free of water. Here, “contains substantially free of water” means that the content of water in relation to the total amount of the conductive pigment paste is usually 1 mass % or less, preferably 0.5 mass % or less, and particularly preferably 0.1 mass % or less.

In the present invention, the water content of the conductive pigment paste can be measured by a Karl Fischer coulometric titration method. Specifically, the water content can be measured by using a Karl Fischer water content meter (product name: MKC-610, available from Kyoto Electronics Manufacturing Co., Ltd.) and setting the temperature of the evaporator (ADP-611, available from Kyoto Electronics Manufacturing Co., Ltd.) provided in the water content meter to 130° C.

From the viewpoints of the solubility of the pigment dispersion resin (A) and the dispersion stability of the conductive pigment paste, the solubility parameter δC of the solvent (C) is preferably 10.0 (cal/cm³)^{1/2} or greater, more preferably in a range from 10.4 to 15.0 (cal/cm³)^{1/2}, and particularly preferably in a range from 10.5 to 13.0 (cal/cm³)^{1/2}.

The solubility parameter of the solvent can be determined according to the method described in the “Polymer Handbook” edited by J. Brandrup and E. H. Immergut, VII Solubility Parameter Values, pp. 519-559 (John Wiley & Sons, 3rd edition, published in 1989). When two or more solvents are used in combination as a mixed solvent, the solubility parameter of the mixed solvent can be determined experimentally, or can be determined through a simple method from the sum of products of the mole fractions and the solubility parameters of the individual liquid solvents.

The “solubility parameter of the solvent (C)” in the present invention is the solubility parameter of all the solvents (mixed solvents) contained in the conductive pigment paste.

From the viewpoints of solubility of the pigment dispersion resin (A) and dispersion stability of the conductive pigment paste, the difference |δA−δC| between the solubility parameter δA of the pigment dispersion resin (A) and the solubility parameter δC of the solvent (C) preferably satisfies a relational expression of |δA−δC|1<2.1, more preferably satisfies a relational expression of |δA−δC|<2.0, even more preferably satisfies a relational expression of |δA−δC|<1.8, and still more preferably satisfies a relational expression of |δA−δC|<1.6.

### Conductive Pigment Paste

The conductive pigment paste that can be used in the manufacturing method of the present invention may optionally contain other components in addition to the pigment dispersion resin (A), the conductive pigment (B), and the solvent (C).

Examples of such other components include a pigment dispersion resin other than the pigment dispersion resin (A), as well as a film-forming resin, a neutralizing agent, an antifoaming agent, an antiseptic agent, a rust inhibitor, a plasticizer, and a pigment other than the conductive pigment (B).

Examples of the film-forming resin and the pigment dispersion resin other than the pigment dispersion resin (A) include, other than the pigment dispersion resin (A), acrylic resins, polyester resins, epoxy resins, polyether resins, alkyd resins, urethane resins, silicone resins, polycarbonate resins, silicate resins, chlorine-based resins, fluorine-based resins, polyvinyl pyrrolidone resins, polyvinyl alcohol resins, polyvinyl acetal resins, styrene-based resins, diene-based resins, polyolefin-based resins, and composite resins thereof. A single type of these resins can be used alone, or two or more types thereof can be used in combination.

Among these, the conductive pigment paste preferably contains a film-forming resin (D). The film-forming resin (D) is a resin that is used for the purpose of forming a coating film, and the concentration of the polar functional group is preferably less than 9 mmol/g, and is more preferably 5 mmol/g or less.

Preferable examples of the film-forming resin (D) include an epoxy resin, a urethane resin, a chlorine-based resin, a fluorine-based resin, a styrene-based resin, a diene-based resin, a polyolefin-based resin, and a composite resin thereof. A single type of these resins can be used alone, or two or more types thereof can be used in combination.

The film-forming resin (D) may be contained at the time of pigment dispersion or may be added and contained after the pigment is dispersed. From the viewpoints of adhesion to a substrate, reinforcement of coating film physical properties, and solvent resistance, the weight average molecular weight of the film-forming resin (D) is preferably 100000 or more, and more preferably from 500000 to 3000000. The solubility parameter of the film-forming resin (D) is preferably less than 10, and more preferably less than 9.3.

From the viewpoints of the solubility and storage stability of the resin, the solubility parameter δD of the film-forming resin (D) and the solubility parameter δC of the solvent (C) preferably satisfy a relational expression of |δD−δC|<3.0. The solubility parameters thereof more preferably satisfy a relational expression of 0≤|δD−δC|<2.8, and even more preferably satisfy a relational expression of 0.1≤|δD−δC|<2.5.

In addition, from the viewpoint of increasing the wettability and/or dispersion stability of the conductive pigment, the paste manufactured by the manufacturing method of the present invention preferably contains a highly-polar low-molecular weight component.

The highly-polar low-molecular weight component is preferably basic or acidic, and may be partially or entirely in the form of a salt. Among these, when the pigment is acidic, a base-containing low molecular weight component is preferable, and when the pigment is basic, an acid group-containing low molecular weight component is preferable.

From the viewpoint of water resistance and the like, the highly-polar low-molecular weight component preferably does not remain in the coating film after solvent evaporation (heating and drying), and the molecular weight is preferably less than 1000, more preferably less than 400, and even more preferably less than 200. The boiling point is preferably 400° C. or lower, more preferably 300° C. or lower, and even more preferably 200° C. or lower.

As the highly-polar low-molecular weight component, for example, an organic acid, an inorganic acid, an organic base, and an inorganic base can be used. Examples of organic acids include organic carboxylic acids (such as formic acid, glutamic acid, acetic acid, propionic acid, benzoic acid, and phthalic acid) and organic sulfonic acids (such as benzenesulfonic acid); examples of inorganic acids include hydrochloric acid, sulfuric acid, nitric acid, and phosphoric acid; examples of organic bases include amine compounds (such as pyridine, methylethanolamine, benzylamine, triethylamine, diazabicycloundecene, and aniline); and examples of inorganic bases include alkali metal hydroxides (such as sodium hydroxide, potassium hydroxide, and lithium hydroxide).

Among these, at least one amine compound containing an amino group is preferable.

The amine value of the amine compound is usually within a range from 5 to 1000 mgKOH/g, preferably from 50 to 1000 mgKOH/g, and more preferably from 105 to 1000 mgKOH/g.

From the viewpoint of improving wettability and/or storage stability of the conductive pigment (B), the lower limit of the content of the highly-polar low-molecular weight component is usually 0.01 mass % or greater, preferably 0.1 mass % or greater, more preferably 3 mass % or greater, and even more preferably 20 mass % or greater, and the upper limit of the content thereof is usually 500 mass % or less, preferably 450 mass % or less, more preferably 400 mass % or less, and even more preferably 300 mass % or less, based on 100 mass % of the solid content of the conductive pigment (B).

Examples of the pigment other than the conductive pigment (B) include white pigments, such as titanium white and zinc white; blue pigments, such as cyanine blue and indanthrene blue; green pigments, such as cyanine green and verdigris; organic red pigments, such as azo-based and quinacridone-based pigments; red pigments, such as red iron oxide; organic yellow pigments, such as benzimidazolone-based, isoindolinone-based, isoindoline-based, and quinophthalone-based pigments; and yellow pigments, such as titanium yellow, and chrome yellow. A single type of these pigments can be used alone, or two or more types thereof can be used in combination. These pigments other than the conductive pigment (B) can be used for purposes such as adjusting the color or reinforcing the physical properties of the film within a range that does not significantly impair the conductivity, and may be simultaneously dispersed together with the pigment dispersion resin (A) and the conductive pigment (B), or may be mixed as a pigment or a pigment paste after the pigment dispersion resin (A) and the conductive pigment (B) have been dispersed to form a paste.

In addition, when the conductive pigment paste is used as a material for a battery electrode, mixing of a relatively large conductive foreign matter into the conductive pigment paste may cause a short circuit and ignition or the like. And thus, preferably, the conductive pigment paste is substantially free of a conductive metal. In the present invention, “substantially free of a conductive metal” means that the content of a conductive metal in the conductive pigment paste is usually 1 mass % or less, preferably 0.5 mass % or less, and particularly preferably 0.1 mass % or less. Moreover, a later-described compounded paste may contain an electrode active material (a composite oxide containing at least one alkali metal and at least one transition metal element).

The content of the pigment other than the conductive pigment (B) is preferably 10 mass % or less, more preferably 5 mass % or less, and even more preferably 1 mass % or less, based on the total amount of pigments in the conductive pigment paste, and particularly preferably, the conductive pigment paste substantially free of the pigment other than the conductive pigment (B).

In the present invention, the particle size distribution is measured on a volume basis according to a laser diffraction-scattering method using a particle size distribution measuring apparatus (product name: Microtrac MT3000, available from MicrotracBEL Corp.). When the average particle size (D50) is determined by over-diluting, with the solvent (C), a conductive pigment paste manufactured using the carbon nanotubes (B-1) as the conductive pigment (B), and measuring the particle size distribution on a volume basis through the laser diffraction-scattering method, from the viewpoint of the stability and conductivity of the paste, the average particle size (D50) is preferably in a range from 0.8 to 4 μm, more preferably in a range from 1 to 3 μm, and even more preferably in a range from 1.2 to 2.5 μm.

When the particle size distribution is determined by over-diluting, with the solvent (C), a conductive pigment paste manufactured using the carbon nanotubes (B-1) as the conductive pigment (B), and measuring the particle size distribution on a volume basis through the laser diffraction-scattering method, from the viewpoints of the stability and viscosity of the paste, the standard deviation of the particle size distribution is preferably 3 μm or less, more preferably 2.5 μm or less, and even more preferably 2 μm or less. The standard deviation of the particle size distribution is calculated by the following Equation (2).

α=[Σ{(d−a)²F}/ΣF]^{1/2} Equation (2)

In Equation (2), σ represents the standard deviation of the particle size distribution, d represents the particle size of each particle, F represents the frequency of particles, and a represents the volume average particle size and is expressed by a=Σ(d)/ΣF.

Note that for a conductive pigment paste prepared using a plurality of types of pigments in addition to the carbon nanotubes (B-1), it is difficult to determine to which pigment the data determined by measurements belongs, and therefore the average particle size (D50) and the standard deviation of the particle size distribution are not calculated through the particle size distribution measurements described above.

Also, in an embodiment of a conductive pigment paste manufactured using, as the conductive pigment (B), the conductive carbon (B-2) having an average primary particle size from 10 to 80 nm, the average particle size (D50) determined by diluting the conductive pigment paste with a solvent and measuring the particle size distribution on a volume basis through the laser diffraction-scattering method is preferably in a range from 400 to 1500 nm, more preferably in a range from 700 to 1300 nm, and even more preferably in a range from 650 to 1150 nm.

In the embodiment using the conductive carbon (B-2), when the average particle size (D50) of the primary particles of the conductive pigment (B) is 1, the average particle size (D50) determined by diluting the conductive pigment paste with the solvent (C) and measuring the particle size distribution on a volume basis through the laser diffraction-scattering method is preferably from 15 to 30, and more preferably from 18 to 25.

Note that in the particle size distribution measurement of the present embodiment, if the conductive pigment paste contains a pigment in addition to the conductive pigment (B), a conductive pigment paste prepared using only the conductive pigment (B) is measured.

The conductive pigment paste can be newly mixed with a conductive pigment (B-3) after manufacturing (after dispersion).

From the viewpoint of conductivity, the conductive pigment (B-3) to be added after manufacturing is preferably carbon nanotubes, conductive carbon, or the like, and may be a dispersion liquid (paste) containing a dispersant, a solvent, or the like. Moreover, after the below-described compounded paste has been manufactured, the conductive pigment (B-3) and the compounded paste may be mixed.

For addition of the conductive pigment (B-3) after the conductive pigment paste has been manufactured, the content ratio of the conductive pigment (B) to the conductive pigment (B-3) is preferably from 1/99 to 99/1 (for example, from 50/50 to 99.9/0.1) in terms of a solid content mass ratio.

### Method for Manufacturing Conductive Pigment Paste

The method for manufacturing the conductive pigment paste of the present invention includes dispersing the above-described components using at least one disperser selected from the group consisting of a bead mill, a homogenizer, a kneader, an extruder, and a planetary mixer.

In the present specification, the term “bead mill” is a general term for a disperser that implements dispersion using beads (media), and a known bead mill can be used without particular limitation. Specific examples include batch type bead mills, such as a paint shaker, a ball mill, a pebble mill, and a planetary ball mill; disk type bead mills in which a shaft having a plurality of disks rotates; and annular bead mills.

In the present specification, the term “homogenizer” is a general term for a disperser that performs dispersion by applying vigorous mechanical action without using beads (media), and a known homogenizer can be used without particular limitation. Specific examples thereof include an ultra-high speed homogenizer that grinds particles in a liquid by high-speed rotation of a rotary inner blade in a fixed outer blade to make the particles fine and uniform, a high-pressure homogenizer that applies a high pressure to a liquid, and causes the liquid to flow through a homogenizing valve and collide with a portion called an impact ring to thereby pulverize the particles, and an ultrasonic homogenizer that applies ultrasonic vibration to a liquid to generate fine bubbles, and pulverizes particles by a large impact caused by the vibrating bubbles bursting in the liquid in a vacuum state.

In the present specification, the term “kneader” is a general term for a device that implements kneading, mixing, and dispersing through a shearing force generated mutually between two blades in a tank and between each of the blades and the tank, and a known kneader can be used without particular limitation.

In the present specification, the extruder is a device that kneads a solid raw material while heating and melting the solid raw material, and extrudes the solid raw material to the outside of a tank, and a known extruder can be used without particular limitation.

In the present specification, the planetary mixer is a device that implements kneading and dispersing by a strong shearing force generated by rotating and revolving blades in a tank, and a known planetary mixer can be used without particular limitation.

Note that in the present invention, the manufacturing method preferably includes dispersing with a bead mill or a homogenizer, and particularly preferably includes dispersing with a bead mill. Further, in the manufacturing method of the present invention, circulation type dispersion is preferably implemented in which a disperser is connected to a tank, and the paste is circulated by a pump.

In the abovementioned circulation dispersion system, preferably, the pigment is initially dispersed at a low pigment concentration, the pigment is charged (added) into a stirring device when the viscosity has been lowered to some extent, and the pigment charging and the dispersion treatment are repeated until the pigment concentration of the paste reaches a desired value.

In the manufacturing method according to the above-described embodiment, by repeating the “pigment charging” and the “dispersion treatment”, the pigment concentration can be brought close to a desired value while maintaining the viscosity of the paste in the dispersion device at a low level, and thereby a highly dispersed and highly concentrated paste can be produced. Note that for the manufacturing method including mixing and dispersing using a media-less disperser described below, it is not necessary to repeat the “pigment charging” and “dispersion treatment” in the circulation dispersion system.

Also, for the manufacturing method including dispersing with a bead mill, a known bead mill can be used without particular limitation, and among such bead mills, an annular bead mill is preferably used. In the present invention, the annular bead mill is a bead mill in which a vessel container having a cylindrical rotor is filled with beads. When the paste to be dispersed passes between the rotating rotor and the inner wall surface of the vessel, the paste is dispersed. Since the paste passes through a relatively narrow region as compared with other methods, deviation of the beads and short passes are reduced, and the dispersion efficiency of the paste becomes uniform. Examples of commercially available annular bead mills include the DCP Mill (trade name) available from Eirich Machines Inc., the Spike Mill (trade name) available from Inoue Mfg., Inc., the Tough Mill (trade name) available from Asada Iron Works Co., Ltd., and the Starmill LMZ (trade name) available from Ashizawa Finetech Ltd.

From the viewpoint of dispersibility, the annular bead mill is more preferably a biaxial driving system-based annular bead mill. In the present invention, the biaxial driving system-based annular bead mill is a bead mill in which a stator, a screw, a screen, and the like are formed inside a cylindrical rotor, and deviation of beads and short passes are reduced as compared with a uniaxial driving system. Specific examples of the biaxial driving system-based annular bead mill include bead mills described in JP 10-005560 A, JP 2003-1082 A, JP 2006-7128 A, and the like. In an embodiment in which an annular bead mill is used, the dispersion speed is preferably a peripheral speed from 5 m/s to 25 m/s, and more preferably from 8 m/s to 20 m/s.

From the viewpoint of dispersibility, in the biaxial driving system-based annular bead mill, the screw, the screen, and the like inside the rotor preferably rotate. A paste having a high concentration can be dispersed by rotating the screw, the screen, and the like in a direction opposite the rotation direction of the rotor.

As a mechanism for separating the dispersed paste in the biaxial driving system-based annular bead mill, a screen type mechanism is used in the inventions of JP 10-005560 A and the like, but in the present invention, the mechanism is not limited to a screen type, and a centrifugal separation type, a gap type, or the like may be used.

Note that with respect to the bead mill, in order to prevent conductive metal foreign matter from being mixed into the paste, the inner surface in contact with the paste is preferably made of a material (for example, an inorganic material) other than a conductive metal. In the present invention, preferably, prior to the step of dispersing using at least one type of disperser selected from the group consisting of a bead mill, a homogenizer, a kneader, an extruder, and a planetary mixer, a powder raw material (P) containing the conductive pigment (B) is charged into a liquid raw material (L) containing the pigment dispersion resin (A) and the solvent (C), and the mixture is then mixed and dispersed using a media-less disperser.

From the viewpoint of dispersibility and manufacturing efficiency, preferably, the media-less disperser has a rotor and a stator in a casing, and the rotor and the stator have functions of mixing, dispersing, and pumping.

In the present embodiment, preferably, prior to the step of dispersing using at least one type of disperser selected from the group consisting of a bead mill, a homogenizer, an ultrasonic disperser, a kneader, an extruder, and a planetary mixer, a powder raw material (P) containing the conductive pigment (B) is charged into a liquid raw material (L) containing the pigment dispersion resin (A) and the solvent (C), and the mixture is mixed and dispersed using a media-less disperser.

In a typical embodiment, the liquid raw material (L) can be produced by mixing the pigment dispersion resin (A), the solvent (C) and other optionally selected components. Examples of the other components include, as described above, a pigment dispersion resin other than the pigment dispersion resin (A), a film-forming resin, a neutralizing agent, an antifoaming agent, an antiseptic agent, a rust inhibitor, a plasticizer, and a pigment other than the conductive pigment (B).

The liquid raw material (L) is charged into the media-less disperser before the powder raw material (P) is charged into the media-less disperser. At this time, the plurality of components contained in the liquid raw material (L) may be mixed together by the media-less disperser.

The powder raw material (P) may be continuously charged into the media-less disperser or may be divided and charged into the media-less disperser over a plurality of times. In addition, the powder raw material (P) may be charged into the media-less disperser by repeating, a plurality of times, an operation of stopping the media-less disperser, charging a portion of the powder raw material (P) into the media-less disperser, and then operating the media-less disperser. However, from the viewpoint of efficiently implementing mixing and dispersion, the powder raw material (P) is more preferably charged into the media-less disperser while operating the media-less disperser.

From the viewpoints of production efficiency and preventing the scattering of the powder raw material, the powder raw material (P) is preferably charged into the media-less disperser by suction. Among the measures for suction, it is particularly preferable that the media-less disperser has a rotor, and the powder raw material (P) is suctioned and charged into the disperser by a negative pressure generated when the rotor rotates. When the powder raw material (P) is suctioned and charged into the disperser by the negative pressure generated when the rotor rotates, the powder raw material (P) can be gradually charged into the system while the disperser is operated, and thus dispersion can be more efficiently implemented. Examples of commercially available products of such media-less dispersers include the Conti-TDS (trade name) available from Dalton Corporation and the CMX (trade name) available from IKA Works, Inc.

In a case in which mixing and dispersion are carried out using the media-less disperser, any one of an annular bead mill, an ultra-high speed homogenizer, or a high-pressure homogenizer is preferably used in a subsequent dispersion step.

The annular bead mill is more preferably the above-described biaxial driving system type from the viewpoint of dispersibility.

The ultra-high speed homogenizer is a media-less disperser in which a rotor having an inner blade rotates at a high speed. The particles are made fine and uniform by collision with the inner blade rotating at a high speed and by the shearing force generated between each of the particles and the outer wall or the fixed outer blade by the high speed rotation. Examples of commercially available ultra-high-speed homogenizers include the Clearmix (trade name) available from M Technique Co., Ltd. and the Filmix (trade name) available from Primix Corporation.

The high-pressure homogenizer is a media-less disperser that causes the paste to pass through a narrow gap by pressurization with a pump, whereby the paste is dispersed and the particles are made fine and uniform through collisions between the particles and a shearing force due to a pressure difference. Examples of commercially available high-pressure homogenizers include the Nanovater (trade name) available from Yoshida Kikai Co., Ltd. and the Star Burst (trade name) available from Sugino Machine Limited.

In a case in which mixing and dispersion are not carried out by the media-less disperser, preferably, before being dispersed, the conductive pigment paste is stirred and mixed in advance by a stirring device such as a disperser, a kneader, an extruder, or a planetary mixer.

### Compounded Paste

The compounded paste used in the manufacturing method of the present invention contains, as essential components, the pigment dispersion resin (A), the conductive pigment (B), and the solvent (C), which are contained in the conductive pigment paste, and other components such as resins, pigments, solvents, and additives may be optionally selected and added to the conductive pigment paste.

Examples of the resins include acrylic resins, polyester resins, epoxy resins, polyether resins, alkyd resins, urethane resins, silicone resins, polycarbonate resins, silicate resins, chlorine-based resins, fluorine-based resins, polyvinylpyrrolidone resins, polyvinyl alcohol resins, polyvinyl acetal resins and composite resins thereof. A single type of these resins can be used alone, or two or more types thereof can be used in combination.

Examples of the pigments include coloring pigments, luster pigments, extender pigments, rust-preventing pigments, and metal particles. A single type of these pigments can be used alone, or two or more types thereof can be used in combination. Among these, when the compounded paste is used as a material of an electrode layer for a battery, the compounded paste preferably contains an electrode active material. Examples of the electrode active material include lithium composite oxides such as lithium nickelate (LiNiO₂), lithium manganate (LiMn₂O₄), lithium cobaltate (LiCoO₂), and LiNi_{1/3}Co_{1/3}Mn_{1/3}O₂; and sodium composite oxides (such as Na_{2/3}Ni_{1/3}Mn_{2/3}O₂). A single type of these electrode active materials can be used alone, or two or more types thereof can be mixed and used.

When the electrode active material is contained, the solid content of the electrode active material in the solid content of the compounded paste is usually from 70 to 99.9 mass %, and is preferably from 80 to 99 mass % from perspectives such as battery capacity and battery resistance.

The solvent is not particularly limited, and the same solvent as the solvent (C) described above can be suitably used. A single type of solvent can be used, or two or more types thereof can be used in combination.

Examples of additives include a neutralizing agent, a pigment dispersant, an antifoaming agent, an antiseptic agent, a rust inhibitor, a plasticizer, and a viscosity modifier.

From viewpoints such as the viscosity during pigment dispersion, pigment dispersibility, storage stability, production efficiency, and conductivity, the content of the pigment dispersion resin (A) in the compounded paste is usually from 0.01 to 80 mass %, preferably from 0.02 to 50 mass %, more preferably from 0.05 to 20 mass %, and particularly preferably from 0.08 to 10 mass %, based on the total solid content of the compounded paste.

The compounded paste can be prepared by uniformly mixing or dispersing the components described above using a known stirrer or disperser such as a disperser, a bead mill, a homogenizer, an ultrasonic disperser, a kneader, an extruder, or a planetary mixer.

### Coating Film (Electrode Layer)

A coating film is formed by applying (coating) the compounded paste described above to an object to be coated.

In the present invention, the coating film refers to a solid film produced by applying a liquid compounded paste to an object to be coated (substrate) and heating and drying the paste. The coating film can be removed from the coated object to produce a conductive film, or can be applied to both surfaces of a plate-like object to be coated (substrate) to produce a conductive material.

The object to be coated is not particularly limited, and examples thereof include metal materials; various plastic materials; inorganic materials such as glass, cement, and concrete: wood; fiber materials (such as paper and cloth); and composite materials thereof. As necessary, these objects to be coated can be appropriately subjected to treatments such as degreasing and surface treatments.

Note that the coating film is preferably applied (coated) on a current collector (preferably an aluminum current collector) as a battery electrode layer.

The electrode layer can be used as, for example, a positive electrode or a negative electrode of a lithium ion battery.

The coating method is not particularly limited as long as the liquid compounded paste can be applied to within a certain film thickness range, and examples of the coating method thereof include roller coating, brush coating, atomization coating, dipping coating, applicator coating, shower coating, roll coater coating, and die coater coating.

The film thickness is preferably from 1 to 200 μm and more preferably from 2 to 150 μm in terms of the dry film thickness.

The drying temperature is preferably from 60 to 300° C. and more preferably from 80 to 200° C.

Of the solvent contained in the compounded paste, preferably 80% or greater, more preferably 90% or greater, and particularly preferably 95% or greater is removed by heating and drying. In addition, when a highly-polar low-molecular weight component is contained, preferably some or all of the highly-polar low-molecular weight component is removed by the heating and drying described above.

### EXAMPLES

Hereinafter, the present invention will be described in more detail with reference to production examples, examples, and comparative examples, but the present invention is not limited to these examples. “Parts” in examples indicates parts by mass, and “%” in examples indicates mass %.

### Method for Manufacturing Pigment Dispersion Resin (A)

### Manufacturing Example 1: Manufacturing of Pigment Dispersion Resin A1

A reaction vessel equipped with a thermometer, a reflux condenser tube, a nitrogen gas inlet tube, and a stirrer was charged with 90 parts of vinyl acetate and 10 parts of acrylic acid as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a carboxylic acid-modified vinyl acetate-vinyl alcohol copolymer (pigment dispersion resin A1) was produced. The produced pigment dispersion resin A1 had a saponification degree of 90 mol %, an SP value of 12.5 (cal/cm³)^{1/2}, a hydroxyl group concentration of 19.2 mmol/g, a carboxyl group concentration of 2.1 mmol/g, and a weight average molecular weight of 17000.

### Manufacturing Example 2: Manufacturing of Pigment Dispersion Resin A2

A reaction vessel equipped with a thermometer, a reflux condenser tube, a nitrogen gas inlet tube, and a stirrer was charged with 90 parts of vinyl acetate and 10 parts of acrylic acid as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a carboxylic acid-modified vinyl acetate-vinyl alcohol copolymer (pigment dispersion resin A2) was produced. The produced pigment dispersion resin A2 had a saponification degree of 60 mol %, an SP value of 11.2 (cal/cm³)^{1/2}, a hydroxyl group concentration of 10.1 mmol/g, a carboxyl group concentration of 1.7 mmol/g, and a weight average molecular weight of 18000.

### Manufacturing Example 3: Manufacturing of Pigment Dispersion Resin A3

A reaction vessel equipped with a thermometer, a reflux condenser tube, a nitrogen gas inlet tube, and a stirrer was charged with 97 parts of vinyl acetate and 3 parts of vinylsulfonic acid as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a sulfonic acid-modified vinyl acetate-vinyl alcohol copolymer (pigment dispersion resin A3) was produced. The produced pigment dispersion resin A3 had a saponification degree of 97 mol %, an SP value of 12.5 (cal/cm³)^{1/2}, a hydroxyl group concentration of 21.1 mmol/g, a sulfonate group concentration of 0.65 mmol/g, and a weight average molecular weight of 15000.

### Manufacturing Example 4: Manufacturing of Pigment Dispersion Resin A4

A reaction vessel equipped with a thermometer, a reflux condenser tube, a nitrogen gas inlet tube, and a stirrer was charged with 97 parts of vinyl acetate and 3 parts of vinylsulfonic acid as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a sulfonic acid-modified vinyl acetate-vinyl alcohol copolymer (pigment dispersion resin A4) was produced. The produced pigment dispersion resin A4 had a saponification degree of 90 mol %, an SP value of 12.2 (cal/cm³)^{1/2}, a hydroxyl group concentration of 18.4 mmol/g, a sulfonate group concentration of 0.61 mmol/g, and a weight average molecular weight of 16000.

### Manufacturing Example 5: Manufacturing of Pigment Dispersion Resin A5

A reaction vessel equipped with a thermometer, a reflux condenser tube, a nitrogen gas inlet tube, and a stirrer was charged with 90 parts of vinyl acetate and 10 parts of 1-pentene-4,5-diol as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a diol-modified vinyl acetate-vinyl alcohol copolymer (pigment dispersion resin A5) was produced. The produced pigment dispersion resin A5 had a saponification degree of 90 mol %, an SP value of 12.6 (cal/cm³)^{1/2}, a hydroxyl group concentration of 22.7 mmol/g, and a weight average molecular weight of 15000.

### Manufacturing Example 6: Manufacturing of Pigment Dispersion Resin A6

A reaction vessel equipped with a thermometer, a reflux condenser tube, a nitrogen gas inlet tube, and a stirrer was charged with 100 parts of vinyl acetate as a polymerizable monomer, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a vinyl acetate-vinyl alcohol copolymer (pigment dispersion resin A6) was produced. The produced pigment dispersion resin A6 had a saponification degree of 90 mol %, an SP value of 12.0 (cal/cm³)^{1/2}, a hydroxyl group concentration of 18.6 mmol/g, and a weight average molecular weight of 20000.

### Manufacturing Example 7: Manufacturing of Pigment Dispersion Resin A9

A reaction vessel equipped with a thermometer, a reflux condenser tube, a nitrogen gas inlet tube, and a stirrer was charged with 90 parts of vinyl acetate and 10 parts of acrylic acid as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure to produce a resin solution. Subsequently, a methanol solution of sodium hydroxide was added to carry out a saponification reaction, the product was thoroughly washed and then dried with a hot air dryer, and a carboxylic acid-modified vinyl acetate-vinyl alcohol copolymer (pigment dispersion resin A9) was produced. The produced pigment dispersion resin A9 had a saponification degree of 50 mol %, an SP value of 10.6 (cal/cm³)^{1/2}, a hydroxyl group concentration of 5.9 mmol/g, a carboxyl group concentration of 1.5 mmol/g, and a weight average molecular weight of 20000.

### Method for Manufacturing Conductive Pigment Paste

### Examples A1 to A26, Comparative Examples A1 to A3

Conductive pigment pastes X-1 A to X-29A were each produced by mixing a pigment dispersion resin (A), a conductive pigment (B), and a solvent (C) of the types and amounts described in Tables 1 to 3 and then dispersing under the dispersion conditions (regarding the disperser and number of passes) described in Table 1. Note that the resin blending amounts shown in the tables are values based on the solid content.

Also note that the number of passes is a unit indicating the number of theoretical processes and is calculated by the following equation.

Processing time (h) required for one pass=paste liquid amount (L)÷disperser processing speed (L/h)

Number of passes (theoretical number of processing times)=processing time (h)÷processing time (h) required for one pass

The water content of each of the conductive pigment pastes X-1A to X-29A was measured according to the Karl Fischer coulometric titration method, and was 0.1 mass % or less in each case. In addition, compounded pastes and electrodes were prepared using the conductive pigment pastes of X-1A to X-26A, batteries were prepared using the compounded pastes and the electrodes, and the batteries exhibited good performance.

A particle size distribution measuring apparatus (product name: Microtrac MT3000, available from MicrotracBEL Corp.) was used to measure the particle size distribution. The conductive pigment paste was over-diluted with the solvent (C), and the particle size distribution on a volume basis was measured by a laser diffraction-scattering method. The results are shown in Table 1. Note that the particle size distribution of X-18A was not measured because a plurality of pigment types was used.

TABLE 1

| | | | Example | Example | Example | Example | Example | Example | Example | Example | Example | Example | Example |
|---|---|---|---|---|---|---|---|---|---|---|---|---|---|
| | | | A1 | A2 | A3 | A4 | A5 | A6 | A7 | A8 | A9 | A10 | A11 |
| Paste name | | | X-1A | X-2A | X-3A | X-4A | X-5A | X-6A | X-7A | X-8A | X-9A | X-10A | X-11A |
| Paste | Dispersion | A1 | 5 | 2 | 1 | 0.5 | | | | | | | |
| com- | resin (A) | A2 | | | | | 2 | | | | | | |
| position | | A3 | | | | | | 2 | | | | | |
| | | A4 | | | | | | | 2 | | | | |
| | | A5 | | | | | | | | 2 | | | |
| | | A6 | | | | | | | | | | | |
| | | A7 | | | | | | | | | | 2 | |
| | | A8 | | | | | | | | | | | 2 |
| | | A9 | | | | | | | | | | | |
| | | A10 | | | | | | | | | | | |
| | Conductive | B1 | 5 | 5 | 5 | 5 | 5 | 5 | 5 | 5 | 5 | S | 5 |
| | pigment (B) | B2 | | | | | | | | | | | |
| | | B3 | | | | | | | | | | | |
| | | B4 | | | | | | | | | | | |
| | Solvent (C) | C1 | 90 | 93 | 94 | 94.5 | 93 | 93 | 93 | 93 | 93 | 93 | 93 |
| | | C2 | | | | | | | | | | | |
| | | C3 | | | | | | | | | | | |
| | | C4 | | | | | | | | | | | |
| SP value difference \|δA − δC\| | | | 1.4 | | | | 0.1 | 1.5 | 1.1 | 1.5 | 0.9 | 1.7 | 1.9 |
| Dispersion | | Disperser type | Biaxial annular | | | | | | | | | | |
| conditions | | Number of passes | 15 passes | | | | | | | | | | |
| Evalu- | Particle size | D50 [μm] | 1.8 | 1.7 | 2.1 | 2.5 | 2.2 | 1.8 | 1.9 | 2.0 | 2.2 | 2.3 | 2.6 |
| ation | | Standard | 0.8 | 1 | 1.5 | 1.9 | 1.8 | 0.9 | 1 | 1.4 | 1.5 | 1.6 | 1.9 |
| | | deviation [μm] | | | | | | | | | | | |
| | Dispersibility | Viscosity | S | S | S | B | A | S | S | S | A | A | B |
| | Stability | Viscosity change | S | S | S | A | A | S | S | A | A | A | B |
| | | over time | | | | | | | | | | | |
| | Conductivity | Volume | B | S | S | B | S | S | S | S | A | B | B |
| | | resistivity | | | | | | | | | | | |

TABLE 2

| | | | Example | Example | Example | Example | Example | Example | Example | Example | Example |
|---|---|---|---|---|---|---|---|---|---|---|---|
| | | | A12 | A13 | A14 | A15 | A16 | A17 | A18 | A19 | A20 |
| Paste name | | | X-12A | X-13A | X-14A | X-15A | X-16A | X-17A | X-18A | X-19A | X-20A |
| Paste | Dispersion | A1 | 2 | 2 | 2 | 2 | 2 | 2 | 2 | | |
| com- | resin (A) | A2 | | | | | | | | | |
| position | | A3 | | | | | | | | | |
| | | A4 | | | | | | | | 2 | 2 |
| | | A5 | | | | | | | | | |
| | | A6 | | | | | | | | | |
| | | A7 | | | | | | | | | |
| | | A8 | | | | | | | | | |
| | | A9 | | | | | | | | | |
| | | A10 | | | | | | | | | |
| | Conductive | B1 | 7 | 6 | 4 | 3 | | | | 5 | 5 |
| | pigment (B) | B2 | | | | | 5 | | | | |
| | | B3 | | | | | | 5 | | | |
| | | B4 | | | | | | | | | |
| | Solvent (C) | C1 | 91 | 92 | 94 | 95 | 93 | 93 | 93 | | |
| | | C2 | | | | | | | | 93 | |
| | | C3 | | | | | | | | | 93 |
| | | C4 | | | | | | | | | |
| SP value difference \|δA − δC\| | | | 1.4 | | | | | | | 1 | 1.8 |
| Dispersion | | Disperser type | Biaxial annular | | | | | | | | |
| conditions | | Number of passes | 15 passes | | | | | | | | |
| Evalu- | Particle size | D50 [μm] | 2.8 | 2.2 | 1.9 | 1.7 | 1.8 | 3.2 | — | 1.8 | 1.7 |
| ation | | Standard | 2 | 1.8 | 0.9 | 0.8 | 1.1 | 0.7 | — | 1.1 | 1.1 |
| | | deviation [μm] | | | | | | | | | |
| | Dispersibility | Viscosity | B | S | S | S | S | S | S | S | A |
| | Stability | Viscosity change | B | S | S | S | S | S | S | S | A |
| | | over time | | | | | | | | | |
| | Conductivity | Volume | A | S | A | B | S | A | A | S | S |
| | | resistivity | | | | | | | | | |

TABLE 3

| | | | Example | Example | Example | Example | Example | Example | Comparative | Comparative | Comparative |
|---|---|---|---|---|---|---|---|---|---|---|---|
| | | | A21 | A22 | A23 | A24 | A25 | A2 | Example Al | Example A2 | Example A3 |
| Paste name | | | X-21A | X-22A | X-23A | X-24A | X-25A | X-26A | X-27A | X-28A | X-29A |
| Paste | Dispersion | A1 | 2 | 2 | 2 | 2 | 2 | 2 | | | |
| com- | resin (A) | A2 | | | | | | | | | |
| position | | A3 | | | | | | | | | |
| | | A4 | | | | | | | | | 2 |
| | | A5 | | | | | | | | | |
| | | A6 | | | | | | | | | |
| | | A7 | | | | | | | | | |
| | | A8 | | | | | | | | | |
| | | A9 | | | | | | | 2 | | |
| | | A10 | | | | | | | | 2 | |
| | | B1 | 5 | 5 | 5 | 5 | 5 | 5 | 5 | 5 | 5 |
| | Conductive | B2 | | | | | | | | | |
| | pigment (B) | B3 | | | | | | | | | |
| | | B4 | | | | | | | | | |
| | Solvent (C) | C1 | 93 | 93 | 93 | 93 | 93 | 93 | 93 | 93 | |
| | | C2 | | | | | | | | | |
| | | C3 | | | | | | | | | |
| | | C4 | | | | | | | | | 93 |
| SP value difference \|δA − δC\| | | | 1.4 | 1.4 | 1.4 | 1.4 | 1.4 | 1.4 | 0.5 | 1.9 | 2.9 |
| Dispersion | | Disperser type | Biaxial anular | | Uniaxial anmilar | | Disc type | | Biaxial annular | | |
| conditions | | Number of | 20 | 12 | 8 | 4 | 60 | 180 | 15 passes | | |
| | | passes | passes | passes | passes | passes | passes | passes | | | |
| Evalu- | Particle size | D50 [μm] | 1.7 | 2.1 | 2.3 | 2.5 | 2.6 | 4.4 | 3.1 | 3.5 | 3.6 |
| ation | | Standard | 0.7 | 1.2 | 1.5 | 1.9 | 1.7 | 2.1 | 2.3 | 2.5 | 2.6 |
| | | deviation [μm] | | | | | | | | | |
| | Dispersibility | Viscosity | A | S | A | B | S | A | C | C | C |
| | Stability | Viscosity change | A | A | A | B | A | B | C | C | C |
| | | over time | | | | | | | | | |
| | Conductivity | Volume | A | S | A | B | A | B | C | C | C |
| | | resistivity | | | | | | | | | |

### Pigment Dispersion Resin (A)

A1: carboxylic acid-modified vinyl acetate-vinyl alcohol copolymer (degree of saponification: 90 mol %, SP value: 12.5, hydroxyl group concentration: 19.2 mmol/g, carboxyl group concentration: 2.1 mmol/g, weight average molecular weight: 17000)
A2: carboxylic acid-modified vinyl acetate-vinyl alcohol copolymer (degree of saponification: 60 mol %, SP value: 11.2, hydroxyl group concentration; 10.1 mmol/g, carboxyl group concentration: 1.7 mmol/g, weight average molecular weight; 18000)
A3: sulfonic acid-modified vinyl acetate-vinyl alcohol copolymer (degree of saponification: 97 mol %, SP value: 12.5, hydroxyl group concentration: 21.1 mmol/g, sulfonate group concentration: 0.65 mmol/g, weight average molecular weight; 15000)
A4: sulfonic acid-modified vinyl acetate-vinyl alcohol copolymer (degree of saponification: 90 mol %, SP value: 12.2, hydroxyl group concentration: 18.4 mmol/g, sulfonate group concentration: 0.61 mmol/g, weight average molecular weight; 16000)
A5: diol-modified vinyl acetate-vinyl alcohol copolymer (degree of saponification: 90 mol %, SP value: 12.6, hydroxyl group concentration: 22.7 mmol/g, weight average molecular weight: 15000)
A6: vinyl acetate-vinyl alcohol copolymer (degree of saponification: 90 mol %, SP value: 12.0, hydroxyl group concentration: 18.6 mmol/g, weight average molecular weight: 20000)
A7: polyvinylpyrrolidone (SP value: 12.8, amide group concentration: 9.1 mmol/g, weight average molecular weight: 10000)
A8: polyacrylic acid (SP value: 13.0, carboxyl group concentration: 13.9 mmol/g, weight average molecular weight: 15000)
A9: carboxylic acid-modified vinyl acetate-vinyl alcohol copolymer (degree of saponification: 50 mol %, SP value: 10.6, hydroxyl group concentration: 5.9 mmol/g, carboxyl group concentration: 1.5 mmol/g, weight average molecular weight: 20000)
A10: polymethyl methacrylate (SP value: 9.23, polar group concentration: 0 mmol/g, weight average molecular weight: 21000)

### Conductive Pigment (B)

B1: carbon nanotubes (multi-walled, average outer diameter: 9 nm, average length: 20 μm)
B2: carbon nanotubes (multi-walled, average outer diameter: 13 nm, average length: 30 μm)
B3: carbon nanotubes (multi-walled, average outer diameter: 150 nm, average length; 6 μm)
B4: carbon black (acetylene black, average primary particle size: 50 nm)

### Solvent (C)

C1: N,N-dimethylacetamide (SP value: 11.1)
C2: N-methyl-2-pyrrolidone (SP value: 11.2)
C3: propylene glycol monomethyl ether (SP value: 10.4)
C4: methyl ethyl ketone (SP value; 9.3)

### Disperser

Biaxial annular: biaxial driving-type annular bead mill described in JP 10-005560 A
Uniaxial annular: Starmill LMZ (trade name, uniaxial drive type annular bead mill) available from Ashizawa Finetech Ltd.
Disk type: DYNO-MILL (trade name, disk-type bead mill) available from Shinmaru Enterprises Corporation
FILMIX: a disperser (non-media type disperser) available from Primix Corporation

### Evaluation Test 1

The conductive pigment pastes prepared by the above manufacturing methods were subjected to an evaluation test by the following evaluation method. The results of the evaluation tests are shown in Tables 1 to 3. In the present invention, it is important that the conductive pigment paste excels in all performance items in the evaluation test. And thus, when an evaluation of “C” is given in any one of the items in the evaluations described in Tables 1 to 3, the conductive pigment paste is considered to be non-passing.

### Viscosity

The viscosity of each produced conductive pigment paste was measured at a shear rate of 1.0 sec⁻¹ using a cone & plate viscometer (trade name Mars 2, available from HAAKE, diameter: 35 mm, cone & plate inclined at 2°), and evaluated according to the following criteria.
S: Viscosity less than 1.0 Pa·s
A: Viscosity greater than or equal to 1.0 Pa·s and less than 2.0 Pa·s
B: Viscosity greater than or equal to 2.0 Pa·s and less than 5.0 Pa·s
C: Viscosity greater than or equal to 5.0 Pa·s

### Storage Stability (Viscosity Increase Rate)

The produced pigment dispersion paste was stored at a temperature of 50° C. for one month, and the initial viscosity and the viscosity after storage were compared. The viscosity was measured at a shear rate of 1.0 s-1 using a cone & plate type viscometer (trade name Mars 2, available from HAAKE, diameter: 35 mm, cone & plate inclined at 2°), and the rate of increase in viscosity was evaluated by the following equation.

Viscosity increase rate (%)=(viscosity after storage)/(initial viscosity)×100−100
S: Viscosity increase rate (%) after storage less than 30%
A: Viscosity increase rate (%) after storage greater than or equal to 30% and less than 100%
B: Viscosity increase rate (%) after storage greater than or equal to 100% and less than 200%
C: Viscosity increase rate (%) after storage greater than or equal to 200%

### Conductivity (Volume Resistivity)

In the volume resistivity measurements, KF polymer L #7305 (trade name, 5% solution of polyvinylidene fluoride, solvent: N-methyl-2-pyrrolidone, available from Kureha Corporation) was used as a binder. The conductive pigment pastes produced in the Examples and Comparative Examples and the KF polymer L #7305 were weighed and measured such that the mass ratio of the conductive pigment in the conductive pigment paste to the polyvinylidene fluoride in the KF polymer L #7305 was 5:100, and were then mixed with an ultrasonic homogenizer for 2 minutes to produce a coating material.

A glass plate (2 mm×100 mm×150 mm) was coated with the coating material by a doctor-blade method, and then heated and dried at 130° C. for 30 minutes. The film thickness of the produced coating film was measured, after which the resistance value was measured with a source meter (2400, available from Keithley Instruments Inc.) using a four point probe (PSP, available from Mitsubishi Chemical Corporation). The volume resistivity was calculated by multiplying the film thickness of the coating film by the resistance value, and was evaluated according to the following criteria.
S: Volume resistivity less than 10 Ω·cm and excellent conductivity
A: Volume resistivity greater than or equal to 10 Ω·cm and less than 15 Ω·cm and good conductivity
B: Volume resistivity greater than or equal to 15 Ω·cm and less than 20 Ω·cm and normal conductivity
C: Volume resistivity greater than or equal to 20 Ω·cm and poor conductivity Otherwise, a coating film having smoothness could not be formed.

### Examples B1 to B25 and Comparative Examples B1 and B2

With respect to the pigment dispersion resin (A), the conductive pigment (B), and the solvent (C) of the types and amounts described in Tables 4 to 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 150 passes. Subsequently, 10 passes of a dispersion treatment were implemented using the biaxial driving-type annular bead mill described in JP 10-005560 A, and conductive pigment pastes X-1B to X-25B, X-34B, and X-35B were produced.

### Example B26

With respect to the pigment dispersion resin (A), the conductive pigment (B), and the solvent (C) of the types and amounts described in Table 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 800 passes, and thereby a conductive pigment paste X-26B was produced.

### Example B27

With respect to the pigment dispersion resin (A), the conductive pigment (B), and the solvent (C) of the types and amounts described in Table 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 150 passes. Subsequently, 40 passes of a dispersion treatment were implemented using the uniaxial driving-type annular bead mill (trade name: Starmill LMZ, available from Ashizawa Finetech Ltd.), and a conductive pigment paste X-27B was produced.

### Example B28

With respect to the pigment dispersion resin (A), the conductive pigment (B), and the solvent (C) of the types and amounts described in Table 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 150 passes. Subsequently, 600 passes of a dispersion treatment were implemented using an ultra-high speed homogenizer (trade name: Filmix, available from Primix Corporation), and a conductive pigment paste X-28B was produced.

### Example B29

With respect to the pigment dispersion resin (A), the conductive pigment (B), and the solvent (C) of the types and amounts described in Table 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 150 passes. Subsequently, 10 passes of a dispersion treatment were implemented using a high-pressure homogenizer (trade name: Nanovater, available from Yoshida Kikai Co., Ltd.), and a conductive pigment paste X-29B was produced.

### Example B30

With respect to the pigment dispersion resin (A), the conductive pigment (B), and the solvent (C) of the types and amounts described in Table 6, a liquid raw material produced by dissolving the pigment dispersion resin (A) in the solvent (C) was charged into a media-less disperser (trade name: Conti-TDS, available from Dalton Corporation), and subsequently, a powder raw material of the conductive pigment (B) was suctioned and charged thereto, and mixing and dispersion were implemented for 150 passes. Subsequently, 110 passes of a dispersion treatment were implemented using a disk-type bead mill (trade name: DYNO-MILL, available from Shinmaru Enterprises Corporation), and a conductive pigment paste X-30B was produced.

### Example B31

With respect to the pigment dispersion resin (A), the conductive pigment (B), and the solvent (C) of the types and amounts described in Table 6, a liquid raw material produced by dissolving the pigment dispersion resin (A) in the solvent (C), and the conductive pigment (B) were charged into a homogenizer (trade name: ULTRA-TURRAX, available from IKA Works, Inc.), the materials were mixed and dispersed for 1.5 hours, and a conductive pigment paste X-31B was produced.

### Example B32

With respect to the pigment dispersion resin (A), the conductive pigment (B), and the solvent (C) of the types and amounts described in Table 6, a liquid raw material produced by dissolving the pigment dispersion resin (A) in the solvent (C), and the conductive pigment (B) were charged into a homogenizer (trade name: ULTRA-TURRAX, available from IKA Works, Inc.), and the materials were mixed and dispersed for 1.5 hours. Subsequently, 10 passes of a dispersion treatment were implemented using the biaxial driving-type annular bead mill described in JP 10-005560 A, and a conductive pigment paste X-32B was produced.

### Example B33

With respect to the pigment dispersion resin (A), the conductive pigment (B), and the solvent (C) of the types and amounts described in Table 6, a liquid raw material produced by dissolving the pigment dispersion resin (A) in the solvent (C), and the conductive pigment (B) were charged into a homogenizer (trade name: ULTRA-TURRAX, available from IKA Works, Inc.), and the materials were mixed and dispersed for 1.5 hours. Subsequently, 600 passes of a dispersion treatment were implemented using an ultra-high speed homogenizer (trade name: Filmix, available from Primix Corporation), and a conductive pigment paste X-33B was produced.

### Comparative Example B3

With respect to the pigment dispersion resin (A), the conductive pigment (B), and the solvent (C) of the types and amounts described in Table 6, a liquid raw material produced by dissolving the pigment dispersion resin (A) in the solvent (C), and the conductive pigment (B) were charged into a disk-type bead mill (trade name: DYNO-MILL, available from Shinmaru Enterprises Corporation), the materials were subjected to a dispersion treatment for 110 passes, and a conductive pigment paste X-36B was produced.

TABLE 4

| | | | | | | | | | | | | | Compar- | Compar- |
|---|---|---|---|---|---|---|---|---|---|---|---|---|---|---|
| | | | | | | | | | | | | | ative | ative |
| | | | Example | Example | Example | Example | Example | Example | Example | Example | Example | Example | Example | Example |
| | | | B1 | B2 | B3 | B4 | B5 | B6 | B7 | B8 | B9 | B10 | B1 | B2 |
| Paste name | | | X-1B | X-2B | X-3B | X-4B | X-5B | X-6B | X-7B | X-8B | X-9B | X-10B | X-34B | X-35B |
| Paste | Dispersion | A1 | 5 | 2 | 1 | | | | | | | | | |
| com- | resin (A) | A2 | | | | 2 | | | | | | | | |
| position | | A3 | | | | | 2 | | | | | | | |
| | | A4 | | | | | | 2 | | | | | | |
| | | AS | | | | | | | 2 | | | | | |
| | | A6 | | | | | | | | | | | | |
| | | A7 | | | | | | | | | 2 | | | |
| | | A8 | | | | | | | | | | 2 | | |
| | | A9 | | | | | | | | | | | 2 | |
| | | A10 | | | | | | | | | | | | 2 |
| | Conductive | B1 | 5 | 5 | 5 | 5 | 5 | 5 | 5 | 5 | 5 | 5 | 5 | 5 |
| | pigment | B2 | | | | | | | | | | | | |
| | (B) | B3 | | | | | | | | | | | | |
| | | B4 | | | | | | | | | | | | |
| | | B5 | | | | | | | | | | | | |
| | | B6 | | | | | | | | | | | | |
| | Solvent (C) | C1 | 90 | 93 | 94 | 93 | 93 | 93 | 93 | 93 | 93 | 93 | 93 | 93 |
| | | C2 | | | | | | | | | | | | |
| | | C3 | | | | | | | | | | | | |
| | | C4 | | | | | | | | | | | | |

| SP value difference \|δA − δC\| | | 1.4 | | | 0.1 | 1.4 | 1.1 | 1.5 | 0.9 | 1.7 | 1.9 | 0.3 | 1.9 |
|---|---|---|---|---|---|---|---|---|---|---|---|---|---|
| Disperser | | α-γ | | | | | | | | | | | |
| Eval- | Water content | S | S | S | S | S | S | S | S | S | S | B | B |
| uation | Viscosity | S | S | S | A | S | S | S | S | A | B | B | C |
| | Storage Stability | S | S | A | A | S | A | S | A | A | B | C | C |
| | Conductivity | B | S | S | A | S | S | S | A | A | B | C | C |

TABLE 5

| | | | | | | | | | | | | | | | Compar- |
|---|---|---|---|---|---|---|---|---|---|---|---|---|---|---|---|
| | | | Exam- | Exam- | Exam- | Exam- | Exam- | Exam- | Exam- | Exam- | Exam- | Exam- | Exam- | Exam- | ative |
| | | | ple | ple | ple | ple | ple | ple | ple | ple | ple | ple | ple | ple | Example |
| | | | B11 | B12 | B13 | B14 | B15 | B16 | B17 | B18 | B19 | B20 | B21 | B22 | B3 |
| Paste name | | | X-11B | X-12B | X-13B | X-14B | X-15B | X-16B | X-17B | X-18B | X-19B | X-20B | X-21B | X-22B | X-36B |
| Paste | Dis- | A1 | 2 | 2 | 2 | 2 | 2 | 2 | 1 | 1 | 1 | 1 | 2 | 1 | 1 |
| com- | persion | A2 | | | | | | | | | | | | | |
| position | resin (A) | A3 | | | | | | | | | | | | | |
| | | A4 | | | | | | | | | | | | | |
| | | A5 | | | | | | | | | | | | | |
| | | A6 | | | | | | | | | | | | | |
| | | A7 | | | | | | | | | | | | | |
| | | A8 | | | | | | | | | | | | | |
| | | A9 | | | | | | | | | | | | | |
| | | A10 | | | | | | | | | | | | | |
| | Con- | B1 | 7 | 6 | 4 | 3 | | | | | | | 4 | 1 | |
| | ductive | B2 | | | | | 5 | | | | | | | | |
| | pigment | B3 | | | | | | 5 | | | | | | | |
| | (B) | B4 | | | | | | | 30 | 20 | 10 | | 1 | 20 | |
| | | B5 | | | | | | | | | | 20 | | | |
| | | B6 | | | | | | | | | | | | | 20 |
| | Solvent | C1 | 91 | 92 | 94 | 95 | 93 | 93 | 69 | 79 | 89 | 79 | 93 | 78 | 79 |
| | (C) | C2 | | | | | | | | | | | | | |
| | | C3 | | | | | | | | | | | | | |
| | | C4 | | | | | | | | | | | | | |

| SP value difference | | 1.4 | | | | | | | | | | | | |
|---|---|---|---|---|---|---|---|---|---|---|---|---|---|---|
| \|δA − δC\| | | | | | | | | | | | | | | |
| Disperser | | α-γ | | | | | | | | | | | | |
| Eval- | Water content | S | S | S | S | S | S | S | S | S | S | S | S | S |
| uation | Viscosity | B | S | S | S | S | S | A | S | S | S | S | S | S |
| | Storage | B | A | S | S | S | S | A | S | S | .A | S | S | S |
| | Stability | | | | | | | | | | | | | |
| | Conductivity | A | S | A | B | S | S | S | A | B | S | S | S | C |

TABLE 6

| | | | Example | Example | Example | Example | Example | Example | Example | Example | Example | Example | Example |
|---|---|---|---|---|---|---|---|---|---|---|---|---|---|
| | | | B23 | B24 | B25 | B26 | B27 | B28 | B29 | B30 | B31 | B32 | B33 |
| Paste name | | | X-23B | X-24B | X-25B | X-26B | X-27B | X-28B | X-29B | X-30B | X-31B | X-32B | X-33B |
| Paste | Dispersion | A1 | | | | 2 | 2 | 2 | 2 | 2 | 2 | 2 | 2 |
| composition | resin (A) | A2 | | | | | | | | | | | |
| | | A3 | 2 | 2 | 2 | | | | | | | | |
| | | A4 | | | | | | | | | | | |
| | | A5 | | | | | | | | | | | |
| | | A6 | | | | | | | | | | | |
| | | A7 | | | | | | | | | | | |
| | | A8 | | | | | | | | | | | |
| | | A9 | | | | | | | | | | | |
| | | A10 | | | | | | | | | | | |
| | Conductive | B1 | 5 | 5 | 5 | S | 5 | 5 | 5 | 5 | 5 | 5 | 5 |
| | pigment (B) | B2 | | | | | | | | | | | |
| | | B3 | | | | | | | | | | | |
| | | B4 | | | | | | | | | | | |
| | | B5 | | | | | | | | | | | |
| | | B6 | | | | | | | | | | | |
| | Solvent (C) | C1 | | | | 93 | 93 | 93 | 93 | 93 | 93 | 93 | 93 |
| | | C2 | | | | | | | | | | | |
| | | C3 | | | | | | | | | | | |
| | | C4 | | | | | | | | | | | |

| SP value difference \|δA − δC\| | | 1.3 | 1.1 | 2.1 | 1.4 | | | | | | | |
|---|---|---|---|---|---|---|---|---|---|---|---|---|
| Disperser | | α-γ | | | α | α\|δ | α\|ε | α\|ζ | α\|η | β | β\|γ | β\|ε |
| Evaluation | Water content | S | S | S | S | S | S | S | B | A | A | A |
| | Viscosity | S | S | B | B | S | S | S | S | B | S | S |
| | Storage Stability | S | A | B | B | A | S | S | S | B | S | S |
| | Conductivity | S | S | A | B | A | S | S | B | B | S | S |

The types of the pigment dispersion resin (A), the types of the conductive pigment (B), the types of the solvent (C), and the types of the disperser in the tables are described below.

### Pigment Dispersion Resin (A)

The blending amount of the pigment dispersion resin in the tables is a value in terms of the solid content.
A1: carboxylic acid-modified vinyl acetate-vinyl alcohol copolymer (degree of saponification: 90 mol %, SP value: 12.5, hydroxyl group concentration: 19.2 mmol/g, carboxyl group concentration: 2.1 mmol/g, weight average molecular weight: 17000)
A2: carboxylic acid-modified vinyl acetate-vinyl alcohol copolymer (degree of saponification: 60 mol %, SP value: 11.2, hydroxyl group concentration: 10.1 mmol/g, carboxyl group concentration: 1.7 mmol/g, weight average molecular weight: 18000)
A3: sulfonic acid-modified vinyl acetate-vinyl alcohol copolymer (degree of saponification: 97 mol %, SP value: 12.5, hydroxyl group concentration: 21.1 mmol/g, sulfonate group concentration: 0.65 mmol/g, weight average molecular weight: 15000)
A4: sulfonic acid-modified vinyl acetate-vinyl alcohol copolymer (degree of saponification: 90 mol %, SP value: 12.2, hydroxyl group concentration: 18.4 mmol/g, sulfonate group concentration: 0.61 mmol/g, weight average molecular weight: 16000)
A5: diol-modified vinyl acetate-vinyl alcohol copolymer (degree of saponification: 90 mol %, SP value: 12.6, hydroxyl group concentration: 22.7 mmol/g, weight average molecular weight: 15000)
A6: vinyl acetate-vinyl alcohol copolymer (degree of saponification: 90 mol %, SP value: 12.0, hydroxyl group concentration; 18.6 mmol/g, weight average molecular weight: 20000)
A7: polyvinylpyrrolidone (SP value: 12.8, amide group concentration; 9.1 mmol/g, weight average molecular weight: 10000)
A8: polyacrylic acid (SP value: 13.0, carboxyl group concentration: 13.9 mmol/g, weight average molecular weight: 15000)
A9: carboxylic acid-modified vinyl acetate-vinyl alcohol copolymer (degree of saponification: 50 mol %, SP value: 10.6, hydroxyl group concentration: 5.9 mmol/g, carboxyl group concentration: 1.5 mmol/g, weight average molecular weight: 20000)
A10: polymethyl methacrylate (SP value: 9.23, polar group concentration: 0 mmol/g, weight average molecular weight: 21000)

### Conductive Pigment (B)

B1: carbon nanotubes (multi-walled, average outer diameter: 9 nm, average length: 20 μm)
B2: carbon nanotubes (multi-walled, average outer diameter: 13 nm, average length: 30 μm)
B3: carbon nanotubes (multi-walled, average outer diameter: 150 nm, average length; 6 μm)
B4: carbon black (acetylene black, average primary particle size: 50 nm)
B5: carbon black (acetylene black, average primary particle size: 20 nm)
B6: graphite (average primary particle size: 10 μm)

### Solvent (C)

C1: N,N-dimethylacetamide (SP value: 11.1)
C2: N-methyl-2-pyrrolidone (SP value: 11.2)
C5: n-butanol (SP value: 11.4)
C4: propylene glycol monomethyl ether (SP value: 10.4)

### Disperser

α: media-less disperser (trade name: Conti-TDS, available from Dalton Corporation)
β: homogenizer (trade name: ULTRA-TURRAX, available from IKA Works, Inc.)
γ: biaxial driving-type annular disperser described in JP 10-005560 A
δ: uniaxial driving-type annular bead mill (trade name: Starmill LMZ, available from Ashizawa Finetech Ltd.)
ε: ultra-high speed homogenizer (trade name: Filmix, available from Primix Corporation)
ζ: high-pressure homogenizer (trade name: Nanovater, available from Yoshida Kikai Co., Ltd.)
η: disk-type bead mill (trade name: DYNO-MILL, available from Shinmaru Enterprises Corporation)

### Evaluation Test 2

The conductive pigment pastes prepared by the above manufacturing methods were subjected to an evaluation test by the following evaluation method. The evaluation results are shown in Tables 4 to 6. In the present invention, it is important that the conductive pigment paste excels in all performance items in the evaluation test. And thus, in the evaluations described in Tables 4 to 6, when an evaluation of “C” is given in any one of the items, the conductive pigment paste is considered to be non-passing.

### Water Content

The water content of the produced conductive pigment paste was measured using a Karl Fischer water content meter (product name: MKC-610, available from Kyoto Electronics Manufacturing Co., Ltd.) with the temperature setting of the evaporator (ADP-611, available from Kyoto Electronics Manufacturing Co., Ltd.) provided in the water content meter set to 130° C.

The water content percentage was calculated based on the total amount of the conductive pigment paste, and was evaluated according to the following criteria.
S: Water content less than 0.1 mass %
A: Water content greater than or equal to 0.1 mass % and less than 0.5 mass %
B: Water content greater than or equal to 0.5 mass % and less than 1 mass %
C: Water content greater than or equal to 1 mass %

### Conductivity (Volume Resistivity)

The conductive pigment pastes of Examples B1 to B16, B21, B23, and B33, and Comparative Examples B1 and B2, in which carbon nanotubes were used as the conductive pigment (or carbon nanotubes were mainly used), were measured and evaluated by the same methods as those of Examples A1 to A26 and Comparative Examples A1 to A4.

The conductive pigment pastes of Examples B17 to B20 and B22 and Comparative Example B3 in which carbon black (acetylene black) or graphite was used (or carbon black (acetylene black) was mainly used) as the conductive pigment were measured and evaluated by the following methods.

KF polymer L #7305 (trade name, 5% solution of polyvinylidene fluoride, solvent: N-methyl-2-pyrrolidone, available from Kureha Corporation) was used as a binder.

Each of the conductive pigment pastes produced in the Examples and Comparative Examples and the KF polymer L #7305 was weighed and measured such that the mass ratio of the conductive pigment in the conductive pigment paste to the polyvinylidene fluoride in the KF polymer L #7305 was 85:10, and was then mixed with an ultrasonic homogenizer for 2 minutes to produce a coating material.

Two aluminum foil tapes (available from Sumitomo 3M Ltd., No. 425) were affixed in parallel at a 3 cm interval on a polypropylene plate (10 cm×15 cm×3 mm). Next, the produced coating material was applied with an applicator between the aluminum foil tapes so as to have a length of 5 cm and a dry film thickness of 15 μm, and was left at room temperature for 2 minutes, and then heated and dried at 80° C. for 10 minutes to form a dry coating film measuring 3 cm (width)×5 cm (length)×15 μm (film thickness).

The volume resistivity of the dried coating film applied between the aluminum foil tapes was measured at 20° C. and 65% RH using a measuring instrument (trade name: Digital Multimeter MODEL 73401, available from Yokogawa Test & Measurement Corporation), and the conductivity was evaluated according to the following criteria.
S: Volume resistivity less than 0.005 Ω·m and excellent conductivity
A: Volume resistivity greater than or equal to 0.005 Ω·m and less than 0.008 Ω·m and good conductivity
B: Volume resistivity greater than or equal to 0.008 Ω·m and less than 0.01 Ω·m and somewhat poor conductivity
C: Volume resistivity greater than or equal to 0.01 f m and very poor conductivity

The viscosity and storage stability (viscosity increase rate) were measured and evaluated by the same methods as in Examples A1 to A26 and Comparative Examples A1 to A4 with the exception that the pastes described in Tables 4 to 6 were used.

### Manufacturing of Compounded Paste and Electrode Layer

### Application Examples Y-1B to Y-33B and Z-1B to Z-33B

50 parts of N,N-dimethylacetamide as a solvent, 1 part of polyvinylidene fluoride (weight average molecular weight: 800000), and 50 parts of active material particles (lithium nickel manganese oxide, average particle size: 5 μm) were added to 100 parts of each conductive pigment paste produced in Examples B1 to B33, the materials were mixed and stirred for 60 minutes using a disperser, and compounded pastes Y-1B to Y-33B serving as Application Examples Y-1B to Y-33B were produced.

Subsequently, each compounded paste Y-1B to Y-33B was applied with an applicator onto a respective aluminum foil (current collector) so as to achieve a dry film thickness of 10 μm, and was dried at a temperature of 180° C. for 40 minutes to produce electrodes Z-1B to Z-33B serving as Application Examples Z-1B to Z-33B.

Each of the produced electrode layers had a residual solvent amount less than 1%, and was an electrode layer having a favorable finish property and good battery performance.

### Method for Manufacturing Conductive Pigment Paste

### Examples C1 to C26 and Comparative Examples C1 to C5

The raw materials described in the following Tables 7 and 8 were blended and subsequently dispersed under the dispersion conditions (disperser and number of passes) described in the tables to produce conductive pigment pastes (X-1C to X-31C). The resin blending amounts described in the tables are based on the solid content.

Also note that the number of passes is a unit indicating the number of theoretical processes and is calculated by the following equation.

Processing time (h) required for one pass=paste liquid amount (L)+disperser processing speed (L/h)

Number of passes (theoretical number of processing times)=processing time (h)+processing time (h) required for one pass

The SP value difference (|δA−δC|), the average particle size (D50), and the evaluation test results (initial viscosity, dispersibility, storage stability, finish property, conductivity, and solvent resistance) of the conductive pastes that were manufactured are also collectively described in Tables 7 and 8.

The water content of each of the conductive pigment pastes (X-1C to X-31C) was measured by the Karl-Fischer coulometric titration method, and was 0.1 mass % or less in each case.

In the present invention, it is important that the conductive pigment paste excels in all performance items in the evaluation test. And thus, when an evaluation of “D (non-passing)” is given with regard to any one of the evaluation items, the conductive pigment paste is considered to be non-passing.

Note that in Comparative Examples 1, 2, 3, and 5, at least one of the evaluation results of the initial viscosity, the dispersibility, and the storage stability was “D (non-passing)”, and thus among the evaluation tests, the finish property, the conductivity, and the solvent resistance were not tested.

TABLE 7

| Examples | | | | | | | | | | |
|---|---|---|---|---|---|---|---|---|---|---|
| and Comparative | | Examples | | | | | | | | |
| Examples | | C1 | C2 | C3 | C4 | C5 | C6 | C7 | C8 | C9 |
| Conductive pigment paste | | X-1C | X-2C | X-3C | X-4C | X-5C | X-6C | X-7C | X-8C | X-9C |
| name | | | | | | | | | | |
| Pigment | A3 | 3 | 3 | 3 | 3 | 3 | 3 | 0.08 | 0.4 | 1.5 |
| dispersion | A1 | | | | | | | | | |
| resin (A) | A9 | | | | | | | | | |
| | A11 | | | | | | | | | |
| | A12 | | | | | | | | | |
| | A8 | | | | | | | | | |
| | A10 | | | | | | | | | |
| Conductive | B7 | | | | 85 | | | | | |
| pigment (B) | B8 | | | | | 85 | | | | |
| | B9 | 85 | 75 | 55 | | | | 85 | 85 | 85 |
| | B10 | | | | | | 85 | | | |
| | B11 | | | | | | | | | |
| Solvent (C) | NMP | 500 | 500 | 500 | 500 | 500 | 500 | 500 | 500 | 500 |
| | DMAC | | | | | | | | | |
| | PGME | | | | | | | | | |
| Highly- | Benzylamine | | | | | | | | | |
| polar low- | Formic acid | | | | | | | | | |
| molecular | Glutamic acid | | | | | | | | | |
| weight | | | | | | | | | | |
| component | | | | | | | | | | |
| Resin (D) | PVDF | 10 | 10 | 10 | 10 | 10 | 10 | 10 | 10 | 10 |
| Disperser | Biaxial annular | 5 | 5 | 5 | 7 | 6 | 4 | 5 | 5 | 5 |
| and number | type | | | | | | | | | |
| of passes | Uniaxial annular | | | | | | | | | |
| | type | | | | | | | | | |
| | Disc type | | | | | | | | | |
| | Filmix | | | | | | | | | |
| SP value difference \|δA − δC\| | | 1.4 | 0.9 | 0.9 | 0.9 | 0.9 | 0.9 | 0.9 | 0.9 | 0.9 |
| Average particle size (D50) | | 1100 | 1150 | 1200 | 700 | 800 | 1300 | 1200 | 1150 | 1100 |
| Evaluation | Initial viscosity | B | B | B | C | B | B | C | C | B |
| Test Results | Dispersibility | A | A | A | B | A | A | C | B | A |
| | Storage Stability | S | S | S | S | S | S | C | B | S |
| | Finish property | S | S | S | A | S | B | C | B | S |
| | Conductivity | A | B | C | A | A | B | A | A | A |
| | Solvent | A | A | A | A | A | A | A | A | A |
| | resistance | | | | | | | | | |

| | | C10 | C11 | C12 | C13 | C14 | C15 | C16 | C17 |
|---|---|---|---|---|---|---|---|---|---|
| Conductive pigment paste | | X-10C | X-11C | X-12C | X-13C | X-14C | X-15C | X-16C | X-17C |
| name | | | | | | | | | |
| Pigment | A3 | 7 | 12 | 16 | | | | | 3 |
| dispersion | A1 | | | | 3 | | | | |
| resin (A) | A9 | | | | | | | | |
| | A11 | | | | | 3 | | | |
| | A12 | | | | | | 3 | | |
| | A8 | | | | | | | 3 | |
| | A10 | | | | | | | | |
| Conductive | B7 | | | | | | | | |
| pigment (B) | B8 | | | | | | | | |
| | B9 | 85 | 85 | 85 | 85 | 85 | 85 | 85 | 85 |
| | B10 | | | | | | | | |
| | B11 | | | | | | | | |
| Solvent (C) | NMP | 500 | 500 | 500 | 500 | 500 | 500 | 500 | 500 |
| | DMAC | | | | | | | | |
| | PGME | | | | | | | | |
| Highly- | Benzylamine | | | | | | | | |
| polar low- | Formic acid | | | | | | | | |
| molecular | Glutamic acid | | | | | | | | |
| weight | | | | | | | | | |
| component | | | | | | | | | |
| Resin (D) | PVDF | 10 | 10 | 10 | 10 | 10 | 10 | 10 | 0.5 |
| Disperser | Biaxial annular | 5 | 5 | 5 | 5 | 4 | 4 | 4 | 5 |
| and number | type | | | | | | | | |
| of passes | Uniaxial annular | | | | | | | | |
| | type | | | | | | | | |
| | Disc type | | | | | | | | |
| | Filmix | | | | | | | | |
| SP value difference \|δA − δC\| | | 0.9 | 0.9 | 0.9 | 1.4 | 0.9 | 0.7 | 1.9 | 0.9 |
| Average particle size (D50) | | 1100 | 1150 | 1200 | 1050 | 1500 | 1500 | 1500 | 1250 |
| Evaluation | Initial viscosity | B | B | B | B | C | C | C | A |
| Test Results | Dispersibility | A | A | B | A | C | C | C | B |
| | Storage Stability | S | S | S | S | C | C | C | C |
| | Finish property | S | A | B | S | C | C | C | B |
| | Conductivity | A | C | C | A | C | C | C | A |
| | Solvent | A | A | A | A | A | A | A | C |
| | resistance | | | | | | | | |

TABLE 8

| | | Examples | | | | | | |
|---|---|---|---|---|---|---|---|---|
| Examples and Comparative Examples | | C18 | C19 | C20 | C21 | C22 | C23 | C24 |
| Conductive pigment paste name | | X-18C | X-19C | X-20C | X-21C | X-22C | X-23C | X-24C |
| Pigment dispersion | A3 | 3 | 3 | 3 | 3 | 3 | 3 | 3 |
| resin (A) | A1 | | | | | | | |
| | A9 | | | | | | | |
| | A11 | | | | | | | |
| | A12 | | | | | | | |
| | A8 | | | | | | | |
| | A10 | | | | | | | |
| Conductive pigment | B7 | | | | | | | |
| (B) | B8 | | | | | | | |
| | B9 | 85 | 85 | 85 | 85 | 85 | 85 | 85 |
| | B10 | | | | | | | |
| | B11 | | | | | | | |
| Solvent (C) | NMP | 500 | | | 500 | 500 | 500 | 500 |
| | DMAc | | 500 | 250 | | | | |
| | PGME | | | 250 | | | | |
| Highly-polar low- | Benzylamine | | | | 4 | 0.02 | | 0.1 |
| molecular weight | Formic acid | | | | | | 0.1 | |
| component | Glutamic acid | | | | | | | |
| Resin (D) | PVDF | 30 | 10 | 10 | 10 | 10 | 10 | 10 |
| Disperser | Biaxial annular type | 7 | 5 | 5 | 5 | 5 | 5 | 5 |
| and number | Uniaxial annular type | | | | | | | |
| of passes | Disc type | | | | | | | |
| | Filmix | | | | | | | |
| SP value difference \|δA − δC\| | | 0.9 | 1.3 | 1.7 | 0.9 | 0.9 | 0.9 | 0.9 |
| Average particle size (D50) | | 900 | 1100 | 1300 | 950 | 1100 | 1050 | 1050 |
| Evaluation Test | Initial viscosity | C | B | C | A | B | A | A |
| Results | Dispersibility | B | A | C | S | S | S | S |
| | Storage Stability | A | S | C | S | S | S | S |
| | Finish property | C | S | C | S | S | S | S |
| | Conductivity | C | A | C | A | A | A | A |
| | Solvent resistance | A | A | A | A | A | A | A |
| | | Examples | | Comparative Examples | | | | |
| Examples and Comparative Examples | | C25 | C26 | C1 | C2 | C3 | C4 | C5 |
| Conductive pigment paste name | | X-25C | X-26C | X-27C | X-28C | X-29C | X-30C | X-31C |
| Pigment dispersion | A3 | 3 | 3 | | | None | 3 | 3 |
| resin (A) | A1 | | | | | | | |
| | A9 | | | 3 | | | | |
| | A11 | | | | | | | |
| | A12 | | | | | | | |
| | A8 | | | | | | | |
| | A10 | | | | 3 | | | |
| Conductive pigment | B7 | | | | | | | |
| (B) | B8 | | | | | | | |
| | B9 | 85 | 85 | 85 | 85 | 85 | | 85 |
| | B10 | | | | | | | |
| | B11 | | | | | | 85 | |
| Solvent (C) | NMP | 500 | 500 | 500 | | 500 | 500 | |
| | DMAc | | | | 500 | | | |
| | PGME | | | | | | | 250 |
| Highly-polar low- | Benzylamine | | | | | | | |
| molecular weight | Formic acid | | | | | | | |
| component | Glutamic acid | 0.3 | | | | | | |
| Resin (D) | PVDF | 10 | 10 | 10 | 10 | 10 | 10 | 10 |
| Disperser | Biaxial annular type | 5 | | 5 | 5 | 5 | 5 | 5 |
| and number | Uniaxial annular type | | 5 | | | | | |
| of passes | Disc type | | | | | | | |
| | Filmix | | | | | | | |
| SP value difference \|δA − δC\| | | 0.9 | 0.9 | 0.9 | 2 | 0.9 | 0.9 | 2.1 |
| Average particle size (D50) | | 1050 | 1400 | 2500 | 3500 | 5000 | 1400 | 5000 |
| Evaluation Test | Initial viscosity | A | C | C | C | D | B | D |
| Results | Dispersibility | S | B | C | D | D | C | D |
| | Storage Stability | S | A | D | D | D | C | D |
| | Finish property | S | A | — | — | — | D | — |
| | Conductivity | A | A | — | — | — | D | — |
| | Solvent resistance | A | A | — | — | — | A | — |

The abbreviations in Tables 7 and 8 are as described below.

### Pigment Dispersion Resin (A)

A3: sulfonic acid-modified vinyl acetate-vinyl alcohol copolymer (degree of saponification: 97 mol %, SP value: 12.5, hydroxyl group concentration: 21.1 mmol/g, sulfonate group concentration: 0.65 mmol/g, weight average molecular weight: 15000)
A1: carboxylic acid-modified vinyl acetate-vinyl alcohol copolymer (degree of saponification: 90 mol %, SP value: 12.5, hydroxyl group concentration: 19.2 mmol/g, carboxyl group concentration: 2.1 mmol/g, weight average molecular weight: 17000)
A9: carboxylic acid-modified vinyl acetate-vinyl alcohol copolymer (degree of saponification: 50 mol %, SP value: 10.6, hydroxyl group concentration: 5.9 mmol/g, carboxyl group concentration: 1.5 mmol/g, weight average molecular weight: 20000)
A11: polyacrylamide (SP value: 12.0, amide group concentration: 14.1 mmol/g, weight average molecular weight: 18000)
A12: hydroxyethyl acrylate-acrylic acid copolymer (SP value: 11.8, hydroxyl group concentration: 4.3 mmol/g, carboxyl group concentration: 6.9 mmol/g, weight average molecular weight: 13000)
A8: polyacrylic acid (SP value: 13.0, carboxyl group concentration: 13.9 mmol/g, weight average molecular weight: 15000)
A10: polymethyl methacrylate (SP value: 9.23, polar group concentration: 0 mmol/g, weight average molecular weight: 21000).

### Conductive Pigment (B)

B7: carbon black (acetylene black) (average primary particle size: 25 nm, pH: 9. BET specific surface area: 115 m²/g)
B8: carbon black (acetylene black) (average primary particle size: 35 nm, pH: 9. BET specific surface area: 70 m²/g)
B9: carbon black (acetylene black) (average primary particle size: 50 nm, pH: 9. BET specific surface area: 36 m²/g)
B10. carbon black (acetylene black) (average primary particle size: 55 nm, pH: 9. BET specific surface area: 28 m²/g)
B11: carbon black (acetylene black) (average primary particle size: 90 nm, pH: 9. BET specific surface area: 9 m²/g).

### Solvent (C)

NMP: N-methyl-2-pyrrolidone (SP value: 11.1)
DMAc: N,N-dimethylacetamide (SP value: 11.2)
PGME: propylene glycol monomethyl ether (SP value: 10.4)

### Coating Film-Forming Resin (D)

PVDF: polyvinylidene fluoride (weight average molecular weight: 800000, SP value: 9.1)

### Highly-Polar Low-Molecular Weight Component

Benzylamine (molecular weight: 107)
Formic acid (molecular weight: 46)
Glutamic acid (molecular weight: 147)

### SP Value Difference (|δA−δC|)

The relationship of |δA−δC| between the solubility parameter δA of the pigment dispersion resin (A) and the solubility parameter δC of the solvent (C) is an absolute value of a value calculated by subtracting the SP value of the solvent (C) from the SP value δA of the pigment dispersion resin (A), and was calculated by the following equation. |δA−δC|=|(SP value of pigment dispersion resin (A))−(SP value of solvent (C))|.

### Disperser

Biaxial annular type: biaxial driving-type annular bead mill described in JP 10-005560 A
Uniaxial annular type: Starmill LMZ (trade name, uniaxial drive type annular bead mill) available from Ashizawa Finetech Ltd.
Disk type: DYNO-MILL (trade name, disk-type bead mill) available from Shinmaru Enterprises Corporation
FILMIX: disperser (non-media type disperser) available from Primix Corporation

### Average Particle Size (D50)

The conductive pigment paste was diluted with the solvent (C), and the volume-based average particle size (D50) was calculated using the laser diffraction-scattering method. A particle size distribution measuring apparatus (product name: Microtrac MT3000, available from MicrotracBEL Corp.) was used to measure the volume-based average particle size (D50).

### Evaluation Test 3

The conductive pigment pastes prepared by the above manufacturing methods were subjected to an evaluation test by the following evaluation method. The evaluation results are presented in Tables 7 and 8. In the present invention, it is important that the conductive pigment paste excels in all performance items in the evaluation test (evaluations of A to C in the evaluations described in Tables 7 and 8). And thus, in the evaluations described in Tables 7 and 8, when an evaluation of “D” is given for any one of the evaluation items, the conductive pigment paste is considered to be non-passing.

### Initial Viscosity

The viscosity (mPa·s) of each produced conductive pigment paste was measured at a shear rate of 0.1 s⁻¹ using a cone & plate viscometer (trade name Mars 2, available from HAAKE, diameter: 35 mm, cone & plate inclined at 2°), and was evaluated according to the following criteria.
A: Viscosity greater than 500 mPa·s and less than 1000 mPa·s
B: Viscosity greater than or equal to 1000 mPa·s and less than 2500 mPa·s
C: Viscosity greater than or equal to 2500 mPa·s and less than 5000 mPa·s
D: Viscosity greater than or equal to 5000 mPa·s

### Dispersibility

In accordance with the dispersibility test of JIS K-5600-2-5, the dispersibility of each produced conductive pigment paste was evaluated according to the following criteria using a particle gauge.
S: The pigment is dispersed at a size less than 10 μm. The dispersibility is excellent.
A: The pigment is dispersed at a size greater than or equal to 10 μm and less than 15 μm. The dispersibility is good.
B: The pigment is dispersed at a size greater than or equal to 15 μm and less than 20 μm. The dispersibility is somewhat good.
C: The pigment is dispersed at a size greater than or equal to 20 μm, but aggregates cannot be visually confirmed. The dispersibility is somewhat poor.
D: Aggregates are visually confirmed. The dispersibility is very poor.

### Storage Stability (Conductive Pigment Paste)

The produced conductive pigment paste was stored at a temperature of 50° C. for one month, and the initial viscosity and the viscosity after storage were compared. The viscosity was measured at a shear rate of 1.0 s⁻¹ using a cone & plate type viscometer (trade name Mars 2, available from HAAKE, diameter: 35 mm, cone & plate inclined at 2°), the rate of increase in viscosity was determined by the following equation, and the storage stability was evaluated according to the following criteria.

Viscosity increase rate (%)=(viscosity (mPa·s) after storage)/(initial viscosity (mPa·s))×100−100
S: Viscosity increase rate (%) after storage less than 10%
A: Viscosity increase rate (%) after storage greater than or equal to 10% and less than 50%
B: Viscosity increase rate (%) after storage greater than or equal to 50% and less than 100%
C: Viscosity increase rate (%) after storage greater than or equal to 100% and less than 200%
D: Viscosity increase rate (%) after storage greater than or equal to 200%

### Finish Property

The appearance of the test plate produced in a later-described conductivity evaluation test was observed, and the finish property was visually evaluated.
S: The test plate has a very uniform appearance.
A: The test plate has a uniform appearance.
B: While portions of slight unevenness are visible, the test plate has a nearly uniform appearance.
C: Unevenness is visually recognized, and the test plate is somewhat inferior.
D: The appearance is clearly non-uniform, and the test plate is inferior.

### Conductivity

Two aluminum foil tapes (available from Sumitomo 3M Ltd., No. 425) were affixed in parallel at a 3 cm interval on a polypropylene plate (10 cm×15 cm×3 mm). Next, the produced conductive pigment paste was applied with an applicator between the aluminum foil tapes so as to have a length of 5 cm and a dry film thickness of 15 μm, and was left at room temperature for 2 minutes, and then heated and dried at 80° C. for 10 minutes to form a dry coating film measuring 3 cm (width)×5 cm (length)×15 μm (film thickness).

The volume resistivity of the dried coating film applied between the aluminum foil tapes was measured at 20° C. and 65% RH using a measuring instrument (trade name: Digital Multimeter MODEL 73401, available from Yokogawa Test & Measurement Corporation), and the conductivity was evaluated according to the following criteria.
S: Volume resistivity less than 0.005 A-m, and most excellent conductivity
A: Volume resistivity greater than or equal to 0.005 Ω·m and less than 0.0065 Ω·m and excellent conductivity
B: Volume resistivity greater than or equal to 0.0065 Ω·m and less than 0.008 Ω·m and good conductivity
C: Volume resistivity greater than or equal to 0.008 Ω·m and less than 0.01 A m and somewhat poor conductivity
D: Volume resistivity greater than or equal to 0.01 Ω·m and very poor conductivity

### Solvent Resistance

Cyclohexanone was brought into contact with the top of the dry coating film used in the conductivity test. After 3 days, the solvent was removed, the state of the coating film after being rubbed with a finger was observed, and the solvent resistance was evaluated according to the following criteria.
A: No change in the state of the coating film.
B: Traces of the solvent (white turbidity) are present on the coating film.
C: The coating film is softened.
D: Some or all of the coating film is detached.

### Application Examples Y-1C and Y-21C

### Manufacturing of Compounded Paste and Positive Electrode Layer

300 parts of N-methyl-2-pyrrolidone and 2 parts of carbon nanotubes (multi-walled, average outer diameter of 9 nm, average length of 20 μm) were mixed into each of 598 parts of the conductive pigment paste (X-1C) produced in Example C1 and 598 parts of the conductive pigment paste (X-2IC) produced in Example C21, each mixture was mixed and stirred for 60 minutes using a disperser, and conductive pigment pastes (X-1-1C) and (X-21-1C) were produced. Next, 120 parts of the electrode active material (lithium composite oxide, LiNi_{1/3}Co_{1/3}Mn_{1/3}O₂) was added to each of the conductive pigment pastes, each mixture was mixed and stirred for 60 minutes using a disperser, and compounded pastes (Y-1C) and (Y-21C) were produced.

Subsequently, an aluminum foil was used as an object to be coated, each of the compounded pastes (Y-1C) and (Y-21C) was applied with an applicator to a respective aluminum foil such that the dry film thickness was 50 μm, and then dried at a temperature of 180° C. for 40 minutes, and the positive electrode layer was produced.

The residual solvent amount was less than 1% in each of the produced electrode layers (two types), and the finish property and battery performance were good for both electrode layers.

### Application Examples Z-1C to Z-26C

### Manufacturing of Compounded Paste and Positive Electrode Layer

50 parts of N-methyl-2-pyrrolidone and 20 parts of an electrode active material (lithium composite oxide. LiNi_{1/3}Co_{1/3}Mn_{1/3}O₂) were added to 100 parts of a respective conductive pigment paste (X-1C to X-26C) produced in Examples C1 to C26, each mixture was mixed and stirred for 60 minutes using a disperser, and compounded pastes (Z-1C to Z-26C) were produced.

Subsequently, each of the compounded pastes was applied with an applicator onto a respective aluminum foil as an object to be coated so as to achieve a dry film thickness of 50 μm, and then dried at a temperature of 180° C. for 40 minutes to produce a positive electrode layer.

Each of the produced electrode layers had a residual solvent amount less than 1% and exhibited a favorable finish property and good battery performance.

1. A method for manufacturing a conductive pigment paste, the method comprising dispersing a paste containing a pigment dispersion resin (A), a conductive pigment (B), and a solvent (C) with at least one disperser selected from the group consisting of a bead mill, a homogenizer, an ultrasonic disperser, a kneader, an extruder, and a planetary mixer, wherein
the pigment dispersion resin (A) comprises at least one polar functional group selected from the group consisting of an amide group, an imide group, an ether group, a hydroxyl group, a carboxyl group, a sulfonate group, a phosphate group, a silanol group, and an amino group,
a polar functional group concentration in the pigment dispersion resin (A) is from 9 to 23 mmol/g,
the conductive pigment (B) comprises carbon nanotubes (B-1) and/or a conductive carbon (B-2) having an average primary particle size from 10 to 80 nm, and
a solubility parameter δA of the pigment dispersion resin (A) and a solubility parameter δC of the solvent (C) satisfy a relationship of δA−δC|<2.1.

2. The method according to claim 1, further comprising, prior to the dispersing with at least one disperser, charging a powder raw material (P) containing the conductive pigment (B) into a liquid raw material (L) containing the pigment dispersion resin (A) and the solvent (C), and mixing and dispersing with a media-less disperser.

3. The method according to claim 1, wherein the bead mill is an annular bead mill.

4. The method according to claim 3, wherein the annular bead mill is a biaxial driving-type annular bead mill.

5. The method according to claim 1, wherein the disperser is a homogenizer, and the homogenizer is an ultra-high speed homogenizer or a high pressure homogenizer.

6. The method according to claim 1, wherein the pigment dispersion resin (A) contains an ionic polyvinyl alcohol.

7. The method according to claim 6, wherein a degree of saponification of the ionic polyvinyl alcohol is greater than or equal to 85 mol % and less than 100 mol %.

8. The method according to claim 1, wherein a solid content of the pigment dispersion resin (A) is from 0.1 to 50 mass % based on a total solid content of the conductive pigment paste.

9. The method according to claim 1, wherein a content of the conductive pigment (B) is from 1 to 90 mass % based on a total amount of the conductive pigment paste, and is from 10 to 99.9 mass % based on a total solid content of the conductive pigment paste.

10. The method according to claim 1, wherein the conductive pigment (B) comprises carbon nanotubes (B-1), and the carbon nanotubes (B-1) contain multi-walled carbon nanotubes.

11. The method according to claim 1, wherein the conductive pigment (B) comprises the carbon nanotubes (B-1).

12. The method according to claim 10, wherein a solid content of the pigment dispersion resin (A) is from 5 to 50 mass % based on a total solid content of the conductive pigment paste.

13. The method according to claim 10, wherein a content of the carbon nanotubes (B-1) is from 1 to 20 mass % based on a total amount of the conductive pigment paste, and is from 10 to 99 mass % based on a total solid content of the conductive pigment paste.

14. The method according to claim 1, wherein the conductive pigment (B) comprises the conductive carbon (B-2) having an average primary particle size from 10 to 80 nm.

15. The method according to claim 14, wherein a solid content of the pigment dispersion resin (A) is from 0.1 to 20 mass % based on a total solid content of the conductive pigment paste.

16. The method according to claim 14, wherein a content of the conductive carbon (B-2) having an average primary particle size from 10 to 80 nm is from 5 to 90 mass % based on a total amount of the conductive pigment paste, and is from 40 to 99.9 mass % based on a total solid content of the conductive pigment paste.

17. The method according to claim 1, wherein the conductive pigment (B) comprises the conductive carbon (B-2) having an average primary particle size from 10 to 80 nm, and the conductive carbon (B-2) is at least one selected from the group consisting of acetylene black, Ketjen black, furnace black, thermal black, graphene, and graphite.

18. The method according to claim 1, wherein the solubility parameter δA of the pigment dispersion resin (A) is 9.3 or greater, and the solubility parameter δC of the solvent (C) is from 10.4 to 15.0.

19. The method according to claim 1, wherein the conductive pigment paste further comprise from 0.01 to 500 mass % of a highly-polar low-molecular weight component based on the conductive pigment (B).

20. The method according to claim 1, wherein the conductive pigment paste further comprise a film-forming resin (D) having a weight average molecular weight greater than or equal to 100000 and a solubility parameter δD less than 9.3.

21. The method according to claim 1, wherein the conductive pigment paste is substantially free of water.

22. The method according to claim 1, wherein the conductive pigment paste is substantially free of metal.

23. The method according to claim 1, wherein the bead mill is a bead mill having an inner surface coated with a material other than a metal.

24. A method for manufacturing an electrode compounded paste, the method comprising
dispersing a paste containing a pigment dispersion resin (A), a conductive pigment (B), and a solvent (C) with at least one disperser selected from the group consisting of a bead mill, a homogenizer, an ultrasonic disperser, a kneader, an extruder, and a planetary mixer, to manufacture a conductive pigment paste, and
adding at least one electrode active material to the conductive pigment paste,
wherein
the pigment dispersion resin (A) comprises at least one polar functional group selected from the group consisting of an amide group, an imide group, an ether group, a hydroxyl group, a carboxyl group, a sulfonate group, a phosphate group, a silanol group, and an amino group, and a polar functional group concentration in the pigment dispersion resin (A) is from 9 to 23 mmol/g,
the conductive pigment (B) comprises carbon nanotubes (B-1) and/or a conductive carbon (B-2) having an average primary particle size from 10 to 80 nm, and
a solubility parameter δA of the pigment dispersion resin (A) and a solubility parameter δC of the solvent (C) satisfy a relationship of |δA−δC|1<2.1.

25. A method for manufacturing a battery electrode layer, the method comprising
dispersing a paste containing a pigment dispersion resin (A), a conductive pigment (B), and a solvent (C) with at least one disperser selected from the group consisting of a bead mill, a homogenizer, an ultrasonic disperser, a kneader, an extruder, and a planetary mixer, to manufacture a conductive pigment paste,
adding at least one electrode active material to the conductive pigment paste to form an electrode compounded paste, and
coating a current collector with the electrode compounded paste,
wherein
the pigment dispersion resin (A) comprises at least one polar functional group selected from the group consisting of an amide group, an imide group, an ether group, a hydroxyl group, a carboxyl group, a sulfonate group, a phosphate group, a silanol group, and an amino group, and a polar functional group concentration in the pigment dispersion resin (A) is from 9 to 23 mmol/g,
the conductive pigment (B) comprises carbon nanotubes (B-1) and/or a conductive carbon (B-2) having an average primary particle size from 10 to 80 nm, and
a solubility parameter δA of the pigment dispersion resin (A) and a solubility parameter δC of the solvent (C) satisfy a relationship of |δA−δC|<2.1.
